(19) United States
(12) Patent Application Publication
(10) Pub. No.: US 2023/0051123 A1
(43) Pub. Date: Feb. 16, 2023

(54) SYSTEM AND METHOD FOR ACCELERATED SETUP OF E-SHOP WEBSITES

(71) Applicant: Wix.com Ltd., Tel Aviv (IL)

(72) Inventors: Nir Domshlak, Petach Tikva (IL); Ariel Perez, Hadera (IL); Amir Gabay, Netanya (IL)

(21) Appl. No.: 17/818,383

(22) Filed: Aug. 9, 2022

Related U.S. Application Data
(60) Provisional application No. 63/233,276, filed on Aug. 15, 2021.

(51) Int. Cl. G06Q 30/06; G06Q 10/08; G06Q 30/02

(52) U.S. Cl. CPC G06Q 30/0631; G06Q 10/087; G06Q 30/0203

(57) ABSTRACT

A system and method for creating and using enabled products sets (EPSs) includes an e-shop developer system in communication with a website building system (WBS), the e-shop developer system to create, modify and update at least one EPS for display in at least one e-shop of a website of the WBS, the at least one EPS to provide continuously updated fulfillment and backend information for its products. The e-shop developer includes an EPS generator tool to provide manual creation and editing services and automatic creation and updating of the at least one EPS, an e-shop builder to receive a user selected at least one EPS and to match the at least one user selected EPS to at least one template for display within the at least one e-shop and an evaluation and integration engine to provide recommendations for the EPS generator tool and the e-shop builder.

### CROSS REFERENCE TO RELATED APPLICATIONS

This application claims priority from U.S. provisional patent application No. 63/233,276, filed Aug. 15, 2021, which is incorporated herein by reference.

### FIELD OF THE INVENTION

The present invention relates to website building systems generally and to e-shops in particular.

### BACKGROUND OF THE INVENTION

Website building systems (WBS) are used by both novices and professionals to create interactive websites. Existing WBSs are based on a visual editing model and most WBSs typically provide multiple templates, with a template possibly including a complete sample website, a website section, a single page or a section of a page.

WBS users (also known as designers, subscribers, subscribing users or site editors) may design the website and the website's end-users (the “users of users”) may access the websites created by the users. Although end-users typically access the system in read-only mode, WBSs (and websites) may allow end-users to perform changes to the web site such as adding or editing data records, adding talkbacks to news articles, adding blog entries to blogs etc. The WBS may in fact allow multiple levels of users (i.e. more than two levels), and assign different permissions and capabilities to each level. Users of the WBS (in particular in the full or partial on-line configurations described below) may register in the WBS server which manages the users, their web sites and accesses by the end-users.

A WBS may be a standalone system, or may be embedded inside a larger editing system. It may also be on-line (i.e. applications are edited and stored on a server), off-line or partially on-line (with web sites being edited locally but uploaded to a central server for publishing). The WBS may use an internal data architecture to store WBS based sites and this architecture may organize the handled sites' internal data and elements inside the system. This architecture may be different from the external view of the site (as seen, for example, by the end-users). It is also typically different from the way the HTML pages sent to the browser are organized.

For example, the internal data architecture may contain additional properties for each element in the page (creator, creation time, access permissions, link to templates, SEO (search engine optimization) related information etc.) which are relevant for the editing and maintenance of the site in the WBS, but are not externally visible to end-users (or even to some editing users). The WBS may implement some of its functionality (including both editing and run-time functionality) on a server or server set, and some of its functionality on client elements. The WBS may also determine dynamically whether to perform some functionality on the server or on the client platform.

A WBS typically handles the creation and editing of visually designed applications (such as a website) consisting of pages, containers and components. Pages may be separately displayed and contain components. Components may include containers as well as atomic components. Reference is made to FIG. 1, which is a schematic block-diagram illustration of a website building system (WBS) 2 which may be used for building a website 3, in accordance with some demonstrative embodiments of the present invention. WBS 2 may be used to build, produce, edit and/or generate website 3, which may comprise pages 4 which may include components 5 (e.g., text, images, videos).

The WBS may also support hierarchical arrangements of components using atomic components (text, image, shape, video etc.) as well as various types of container components which contain other components (e.g. regular containers, single-page containers, multi-page containers, gallery containers etc.). The sub-pages contained inside a container component are referred to as mini-pages, and each of which may contain multiple components. Some container components may display just one of the mini-pages at a time, while others may display multiple mini-pages simultaneously.

The components may be content-less, or have internal content. An example of the first category is a star-shape component, which does not have any internal content (though it has color, size, position, attributes and other parameters). An example of the second category is a text paragraph component, whose internal content includes the internal text as well as font, formatting and layout information (which is also part of the content rather than being attributes of the component). This content may, of course, vary from one instance of the text paragraph component to another. Components which have content are often referred to as fields (e.g. a “text field”).

Pages may use templates, general page templates or component templates. Specific cases for templates include the use of an application master page containing components replicated in all other regular pages, and the use of an application header or footer (which repeat on all pages). Templates may be used for the complete page or for page sections. The WBS may provide inheritance between templates, pages or components, possibly including multi-level inheritance, multiple inheritance and diamond inheritance (i.e. A inherits from B and C and both B and C inherit from D).

The visual arrangement of components inside a page is called a layout. The WBS may also support dynamic layout processing, a process whereby the editing of a given component (or other changes affecting it such as externally-driven content change) may affect other components, as further described in U.S. Pat. No. 10,185,703 entitled “Website Design System Integrating Dynamic Layout and Dynamic Content” granted 22 Jan. 2019, commonly owned by the Applicant and incorporated herein by reference.

A WBS may be extended using add-on applications such as a third party application and its components (TPA's), list applications (such as discussed in US Patent Publication No. US 2014/0282218 entitled “WBS Integrating Data Lists with Dynamic Customization and Adaptation” published 18 Sep. 2014, commonly owned by the Applicant and incorporated herein by reference) and WBS configurable applications (WCA's—such as described in US Patent Publication No. 2020/0151226 entitled “System And Method for Creation and Handling of Configurable Applications for Website Building Systems” published 14 May 2020 commonly owned by the Applicant and incorporated herein by reference). These third party applications and list applications may be added and integrated into designed websites.

Such third party applications and list applications may be purchased (or otherwise acquired) through a number of distribution mechanisms, such as being pre-included in the WBS design environment, from an Application Store (integrated into the WBS's market store or external to it) or directly from the third party application vendor.

The third party application may be hosted on the WBS vendor's own servers, the third party application vendor's server or on a 4th party server infrastructure.

The WBS may also allow procedural code to be added to some or all of the system's entities. Such code could be written in a standard language (such as JavaScript), an extended version of a standard language or a language proprietary to the specific WBS. The executed code may reference APIs provided by the WBS itself or external providers. The code may also reference internal constructs and objects of the WBS, such as pages, components and their attributes.

The procedural code elements may be activated via event triggers which may be associated with user activities (such as mouse move or click, page transition etc.), activities associated with other users (such as an underlying database or a specific database record being updated by another user), system events or other types of conditions. The use of such procedural code elements is further described in U.S. Pat. No. 10,209,966 entitled “Custom back-end functionality in an online website building environment” granted 19 Feb. 2019, commonly owned by the Applicant and incorporated herein by reference.

The activated code may be executed inside the WBS's client element, on the server platform or by using a combination of the two or a dynamically determined execution platform. Such a system is described in US Patent Publication No. US 2018/0293323 entitled “System and Method for Smart Interaction Between Website Components” published 11 Oct. 2018, commonly owned by the Applicant and incorporated herein by reference.

Typical site creation may be based on a number of models, including a visual editing model (in which the user edits a previously created site) and an automatic site generation model or a combination thereof as illustrated in FIG. 2 to which reference is now made and is described in U.S. Pat. No. 10,073,923 entitled “System and Method for the Creation and Update of Hierarchical Websites Based on Collected Business Knowledge” granted 11 Sep. 2018, commonly owned by the Applicant and incorporated herein by reference.

It will be appreciated that throughout the specification, the acronym WBS may be used to represent a website building system. FIG. 2 illustrates a system 100 that comprises a typical WBS 2 in communication with client systems operated by WBS vendor staff 61, a site designer 62 (i.e. a user), a site user 63 (i.e. user of user) and with external systems 70. WBS 2 may further comprise a WBS site manager 10, an object marketplace 15, a WBS RT (runtime) server 20, a WBS editor 30, a site generator system (SGS) 40 and a WBS content management system (CMS) 50. It will be appreciated that the elements of FIG. 2 may function as described in U.S. Pat. No. 10,073,923.

In the visual editing model, the user (designer) edits a site based on one or more website templates. The WBS provider may provide multiple site (or other) templates, with each template possibly including a complete sample web site, a web site section, a single page or a section of a page. Users may have the option to start with an empty site (essentially a “blank page” template) but would typically start with an actual site template.

The WBS provider may provide site templates ranging from the very generic (e.g. mobile site, e-store) through the more specific (e.g. law office, restaurant, florist) to the highly specific ones (e.g. a commercial real-estate law office or a Spanish tapas restaurant). Such templates are typically stored in a repository accessible to users of the WBS and are typically classified according to business type, sub-type or industry. Templates may also be created (and classified) according to style, color range or other parameters and not just according to business type. Site templates may be extended with additional (typically back-end) functionality, services and code in order to become full-fledged vertical solutions integrated with the WBS.

Thus, the user's first experience when creating a site using a WBS visual editor may typically be that the user chooses a template (e.g. according to style or industry type/sub-type), possibly a blank template and then edits the template in the visual editor including the editing of content, logic, layout and attributes. Such editing may include (in particular) adapting the template and its elements to the details of the user's business. The user may then publish the modified site.

Under the site generation model, the WBS generates an initial site for the user, based on a selected template, possibly modified by filling-in common elements of information, and possibly allowing follow-up editing of the generated site. This filling-in is required as various pieces of information (such as the business name or a description of the management team) are included in multiple locations in the template's pages. Thus, the user may have to change the business name (for example) in multiple places throughout the template.

Furthermore, some template elements (e.g. a generic product page) may appear multiple times, with each instance displaying the details of a different instance of an underlying entity (e.g. different products offered in the site). Such multiple instances may be manually specified (e.g. the details of different persons in the company's management team) or dynamically derived from an external database (e.g. product details from the “products on sale” database). Such an arrangement is often known as a “repeater”.

The template may also include fields. For example, the WBS may allow the template designer to specify fields (also known as “placeholders”) for the insertion of values inside the templates, such as {CompanyName}, {ProductName}, {ProductPrice} etc. The user may also specify the values for the fields defined in the template selected for the website.

The WBS may allow the user to enter simple or complex values (e.g. text and images), as well as additional (non-field) information such as selection of included pages or web site areas, colors, style information, links, formatting options, website display options, decoration elements (such as borders and backgrounds) etc.

The WBS may also allow the user to enter some of this additional information before selecting a template, and use this information to help in selecting a template (e.g. by narrowing the set of proposed templates). For example, the user may select a certain generic color scheme (e.g. pastel colors) or style (e.g. business/formal), and the system may then use this selection to narrow the set of proposed templates.

The system may also display a series of views or questionnaires to allow the user to enter values or selections (for both the defined fields and the additional information above). The system may further create a connection (or binding) between a multiple-instance element of the template (as described herein above) and an internal or external database which provides the data instances used to generate the displayed instances.

Once a template has been selected and its fields and additional information have been specified (e.g. through the questionnaires or through binding to data sources), the WBS may generate the website containing the combined information. The user may then publish the site (through the WBS or otherwise).

A WBS may support SEO review for application constructed in the WBS, as discussed in US Patent Publication No. US 2019/0026280 entitled “System and method for integration of search engine optimization in website building systems” published 24 Jan. 2019, commonly owned by the Applicant and incorporated herein by reference.

A WBS may perform semi-automatic site creation using a different model as described in U.S. Pat. No. 10,073,923. Under this model, the system gathers information on the user and his web site requirements from multiple sources which may include, for example: user-filled questionnaires; existing user presence (such as existing web sites or social media presence), industry sources (such as general trade web sites), off-line information and internal system repositories which provide information on specific business types, such as basic template information for specific business types (lawyers, restaurants, plumbers, graphic designers etc.), possibly refined for specific industries (e.g. distinguishing between real-estate lawyers and personal injury lawyers).

The system may also gather external information from other sites, both internal and external to the system. Such information may affect, for example, the selection of offered questionnaires and layout elements, proposed defaults etc. Such information may also typically be collected on a statistical or summary basis, in order not to expose information belonging to any single user, and protect users' privacy, anonymity and legal rights (such as copyrights). Such information may be located based on information provided by the user which may be direct (e.g. an existing website address) or indirect (a business name and geographical address which can be used to locate information about the business).

The gathered information is analyzed and arranged into a repository of content elements which are then mapped onto layout elements which present the content from the content elements and combine the layout elements to form the site. The layout element mapping, selection and combination process may be fully automatic or semi-automatic (i.e. including user interaction).

To support the above mentioned functionality above, a WBS will typically maintain a series of repositories, stored over one or more servers or server farms. Such repositories may typically include various related repositories such as a user information/profile repository, a WBS (WBS) component repository, a WBS site repository, a Business Intelligence (BI) repository, an editing history repository, a third party application store repository, etc. The system may also include site/content creation related repositories such as a questionnaire type repository, a content element type repository, a layout element type repository, a design kit repository, a filled questionnaires repository, a content element repository, a layout element repository, a rules repository, a family/industry repository etc. A description of these repositories may be found in U.S. Pat. No. 10,073,923.

Ecommerce platforms exist in the art which allow commercial transactions over the internet such as business to business and business to consumer, typically through an e-shop. Ecommerce platforms enable online commerce for merchants and consumers and can manage tasks such as web hosting, inventory management, payment processing, marketing and order fulfillment.

An e-shop is an online shopping website from which a user or purchaser may acquire goods from a merchant over the internet. A typical online store enables the customer to browse the firm's range of products and services, view photos or images of the products, along with information about the product specifications, features and prices. WBSs are also associated with ecommerce platforms which allow for the integration of e-shops

Some prior art systems implement a framework that allows an e-shop owner to organize their products for sale with the ability to group them based on certain criteria (new sale, featured bestseller etc.) They can display products from a predefined list such as manufacturer or vendor or can create a custom list of products.

### SUMMARY OF THE PRESENT INVENTION

There is provided, in accordance with a preferred embodiment of the present invention, a system for creating and using enabled products sets (EPS s). The system includes a processor and an e-shop developer system running on the processor in communication with a website building system (WBS), the e-shop developer system to create, modify and update at least one EPS for display in at least one e-shop of a website of the WBS; the at least one EPS to provide continuously updated fulfillment and backend information for its products. The e-shop developer includes an EPS generator tool to provide manual creation and editing services and automatic creation and updating of the at least one EPS, an e-shop builder to receive a user selected at least one EPS and to match the at least one user selected EPS to at least one template for display within the at least one e-shop and an evaluation and integration engine to provide recommendations for the EPS generator tool and the e-shop builder according to at least one of: definitions of the website, site designer information, e-shop end-user activity internal and external to the e-shop developer system, industry standard databases and at least one ML (machine learning) model.

Moreover, in accordance with a preferred embodiment of the present invention, the e-shop developer system is integrated with the WB S.

Further, in accordance with a preferred embodiment of the present invention, the system includes at least one database to store at least one of: website definitions, e-commerce information, site designer information, editing history of the website, business information of the website, content of the website and site user information.

Still further, in accordance with a preferred embodiment of the present invention, the EPS generator tool further includes at least one of: an EPS editor to enable the user to create and edit the at least one EPS, an updater to handle both manual and automatic updates to products and their attributes of the at least one EPS from different sources, a schema matcher to map between the supplier product information schema and the e-shop developer system schema for products of the at least one EPS, a questionnaire presenter to present at least one questionnaire to the user and to receive input for the evaluation and integration engine from the at least one questionnaire, a spatial EPS evaluator to evaluate at least one of completeness, diversity and fulfillment optimization for the at least one EPS, and an automatic EPS generator to create the at least one EPS according to the updater, the schema matcher, the questionnaire generator and the spatial EPS evaluator.

Additionally, in accordance with a preferred embodiment of the present invention, the updater further includes at least one of: an API handler to communicate with a product supplier to receive fulfillment and product update information for a product, and a change merge module to manage the merging of the product update information with changes made by the user.

Moreover, in accordance with a preferred embodiment of the present invention, the API handler uses at least one of an API (application programming interface), an SPI (Service provider interface), a web services based connection and system to system communication.

Further, in accordance with a preferred embodiment of the present invention, the e-shop builder includes at least one of: an e-shop editor to enable the user to select and edit the user selected at least one EPS for the at least one e-shop, an EPS template associator to find templates to display the user selected at least one EPS using pre-associations, an EPS template searcher to search in template repositories and provide automatic template construction for the user selected at least one EPS, an EPS template generator to generate the at least one template for the user selected at least one EPS at runtime, and an e-shop previewer to provide a preview of the at least one e-shop before publication.

Still further, in accordance with a preferred embodiment of the present invention, the e-shop editor includes a product updater to receive manual product updates for at least one product and to update related EPSs including the at least one product accordingly.

Additionally, in accordance with a preferred embodiment of the present invention, the e-shop previewer includes a website analyzer to determine how elements of the at least one e-shop are to be displayed on the website.

Moreover, in accordance with a preferred embodiment of the present invention, the evaluation and integration engine includes an information gatherer to gather information from the at least one database and operational data from external monitoring or data collection systems, at least one ML (machine learning) model, a ML (machine learning) trainer to train the at least one ML model, an information analyzer to analyze the gathered information to provide input for the at least one ML model, and a recommender to make recommendations for the at least one EPS according to the information analyzer and the at least one ML model.

Further, in accordance with a preferred embodiment of the present invention, the information analyzer includes at least one of: a feature extractor to create feature vectors for the at least one ML model, a channel effectiveness analyzer to determine channel effectiveness for channels of the at least one EPS, where the channels comprise at least different advertising platforms, an aggregator to aggregate e-commerce information and operational data for the at least one EPS, and a scorer and ranker to provide scoring and ranking for at least one of: construction of the at least one EPS, construction of the at least one e-shop and shop access by the at least one e-shop end-user.

Still further, in accordance with a preferred embodiment of the present invention, the at least one EPS is at least one of persistent and virtual.

Additionally, in accordance with a preferred embodiment of the present invention, the user is at least one of a merchant, a catalog curator, a website designer, an e-shop designer, WBS vendor staff, a product supplier, a marketplace provider and a drop shipper.

Moreover, in accordance with a preferred embodiment of the present invention, attributes of products in the at least one EPS are defined for different levels of the user.

There is provided, in accordance with a preferred embodiment of the present invention, a method for creating and using enabled products sets (EPS s). The method includes creating, modifying and updating at least one EPS for display in at least one e-shop of a website of a website building system (WBS); the at least one EPS to provide continuously updated fulfillment and backend information for its products, the creating, modifying and updating includes providing manual creation and editing services and automatic creation and updating of the at least one EPS; receiving a user selected at least one EPS, matching the at least one user selected EPS to at least one template for display within the at least one e-shop, and providing recommendations for the EPS generator tool and the e-shop builder according to at least one of: definitions of the website, site designer information, e-shop end-user activity internal and external to the e-shop developer system, industry standard databases and at least one ML (machine learning) model.

Moreover, in accordance with a preferred embodiment of the present invention, the method further includes storing in at least one database at least one of: website definitions, e-commerce information, site designer information, editing history of the website, business information of the website, content of the website and site user information.

Further, in accordance with a preferred embodiment of the present invention, the providing manual creation and editing services includes at least one of: enabling the user to create and edit the at least one EPS, handling both manual and automatic updates to products and their attributes of the at least one EPS from different sources, mapping between the supplier product information schema and the e-shop developer system schema for products of the at least one EPS, presenting at least one questionnaire to the user, receiving input for the evaluation and integration engine from the at least one questionnaire, evaluating at least one of: completeness, diversity and fulfillment optimization for the at least one EPS, and creating the at least one EPS according to the handling both manual and automatic updates, the mapping, the receiving input and the evaluating.

Still further, in accordance with a preferred embodiment of the present invention, the handling both manual and automatic updates further includes at least one of: communicating with a product supplier to receive fulfillment and product update information for the product; and managing the merging of the product update information with changes made by the user.

Additionally, in accordance with a preferred embodiment of the present invention, the communicating with a product supplier uses at least one of an API (application programming interface), an SPI (Service provider interface), a web services based connection and system to system communication.

Moreover, in accordance with a preferred embodiment of the present invention, the matching includes at least one of: enabling the user to select and edit the user selected at least one EPS for the at least one e-shop, finding templates to display the user selected at least one EPS using pre-associations, searching in template repositories and providing automatic template construction for the user selected at least one EPS, generating the at least one template for the user selected at least one EPS at runtime, and providing a preview of the at least one e-shop before publication.

Further, in accordance with a preferred embodiment of the present invention, the enabling the user includes receiving manual product updates for at least one product and updating related EPSs including the at least one product accordingly.

Still further, in accordance with a preferred embodiment of the present invention, the providing a preview includes a website determining how elements of the at least one e-shop are to be displayed on the website.

Additionally, in accordance with a preferred embodiment of the present invention, the providing recommendations includes gathering information from the at least one database and operational data from external monitoring or data collection systems, using at least one ML (machine learning) model, training the at least one ML model, analyzing the gathered information to provide input for the for the at least one ML model; and making recommendations for the at least one EPS according to the analyzing the gathered information and the using at least one ML model.

Moreover, in accordance with a preferred embodiment of the present invention, the analyzing the gathered information includes at least one of creating feature vectors for the at least one ML model, determining channel effectiveness for channels the the at least one EPS, where the channels includes at least different advertising platforms, aggregating e-commerce information and operational data for the at least one EPS, and providing scoring and ranking for at least one of: construction of the at least one EPS, construction of the at least one e-shop and shop access by the e-shop end-user.

Further, in accordance with a preferred embodiment of the present invention, the at least one EPS is at least one of persistent and virtual.

Still further, in accordance with a preferred embodiment of the present invention, the user is at least one of a merchant, a catalog curator, a website designer, an e-shop designer, WBS vendor staff, a product supplier, a marketplace provider and a drop shipper.

Additionally, in accordance with a preferred embodiment of the present invention, attributes of products in the at least one EPS are defined for different levels of the user.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic block-diagram illustration of a website building system (WBS) which may be used for building a website;

FIG. 2 is a schematic illustration of a system for the creation and update of hierarchical web sites;

FIG. 3 is a schematic illustration of system of an e-commerce platform integrated with a website building system; constructed and operative in accordance with the present invention;

FIG. 4 is a schematic illustration of the elements of the e-shop developer of FIG. 3; constructed and operative in accordance with the present invention;

FIG. 5 is a schematic illustration of the elements of the EPS (enabled product set) generator tool of FIG. 4, constructed and operative in accordance with the present invention;

FIG. 6 is a schematic illustration of the evaluation and integration engine of FIG. 4, constructed and operative in accordance with the present invention;

FIG. 7 is a schematic illustration of the elements of the information analyzer of FIG. 6, constructed and operative in accordance with the present invention;

FIG. 8 is a schematic illustration of the elements of the e-shop builder of FIG. 4, constructed and operative in accordance with the present invention;

FIGS. 9A to 9C are example screenshots of user interfaces used for EPS building, constructed and operative in accordance with the present invention;

FIGS. 10A to 10E are example screenshots of user interfaces used for e-shop building, constructed and operative in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Existing WBSs typically allow the merchant to select an e-shop template when building an e-shop. However, these templates usually include a set of dummy products which need to be manually replaced. Therefore, the merchant setting up or updating his e shop has to review the template, replace these dummy products with actual ones and set up the required backend information (including fulfilment means and prices).

When setting up an e-shop, in many cases, a merchant typically needs to set up a large collection or set of products quickly. This could happen when (for example), the merchant opens a new e-shop, the merchant opens a new section in an existing e-shop, or when the merchant opens a specialized or a modified version of an existing e-shop (which doesn't use the same product set). An example would be opening a shop section adapted to a specific market that is somewhat different in character. Other scenarios may be when the merchant opens a version of an e-shop adapted to a given season, holiday, or another event (such as the Black Friday sale) or when an existing website owner which doesn't have an e-shop and wants to open one. An example would be a yoga instructor who would like to add a yoga goods e-shop to their existing website (for use by the instructor's existing clients). Alternatively, a user may wish to transfer an existing e-shop (including its backend information) to another user essentially doing a business hand-over.

Applicant has realised that a particular problem in setting up a collection of products in an e-shop, is the setting up of the various vendor and logistics information (such as fulfillment and backend information described in more detail herein below). In addition, different products may have different setup requirements.

Applicant has further realized that these issues may be overcome with a system that uses enabled product sets (EPSs) and that can rapidly deploy pre-populated EPSs for use within the e-shop creation environment enabling a merchant to set up and manage his e-shop quickly and efficiently providing an accelerated e-shop setup process. It will be appreciated that an EPS may be likened to a smart product collection.

The system may allow the merchant to select an EPS and use it to jump-start an e-shop. The selected EPS may include live prices, fulfilment information, and required backend information (e.g., supplier details). Furthermore, the EPS may include a curated list of products. For example, a yoga trainer may drop ship in a yoga goods shop adapted for his business website. The yoga trainer may have his own clients from the yoga classes (the “services side” of the business) may to start selling to them immediately. As the EPS provides a backend drop-shipper connection, the yoga trainer does not need to handle the logistics involved in operating the e-shop or delivering orders to clients.

Thus, an e-shop designer/merchant/owner may be able to fill his shop with products at the touch of a button without having to handle any fulfilment and backend information. The system may be part of an e-Commerce Platform (ECP) which may deployed in conjunction with a WBS as discussed in more detail herein below.

EPSs may be functional, the products in the EPS are matched with appropriate fulfillment or drop-shipping services. This matching allows the EPS to “go live” rapidly. In addition, such matching may include the requisite technical elements (interfaces for product selection, offering, product schema adaptation, data transformation, billing/payment, order processing, and order tracking) needed to provide the products to the customers. They may also be dynamic, allowing for automatic updates of product information from both the supplier and the merchant owning the e-shop.

EPSs may also be harmonious, the different products in the EPS form a combination that is beneficial to the customer or provides a desired set of attributes, options or features. Thus, such a combination of products works together in an e-shop in terms of pricing, design, quality, color etc.

Applicant has further realized that the use of EPSs provides a unique e-shop development process, and the system may make use of information available inside the ECP/WBS ecosystem and information and BI (business information) gathered outside the ECP/WBS ecosystem in deciding which products to display.

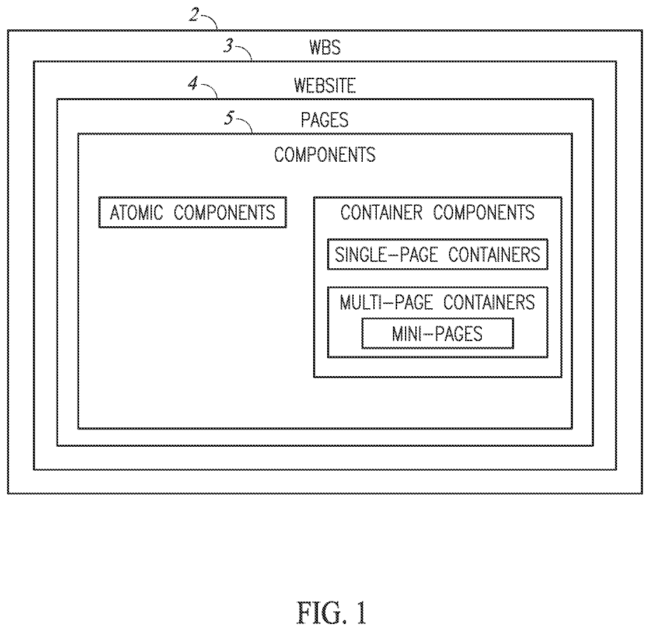

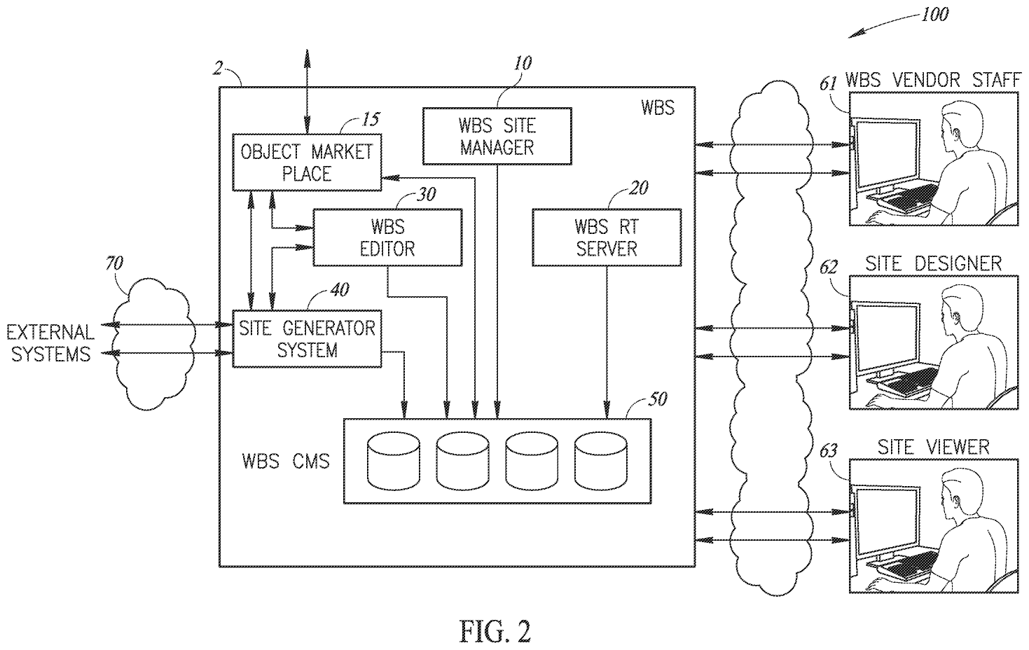

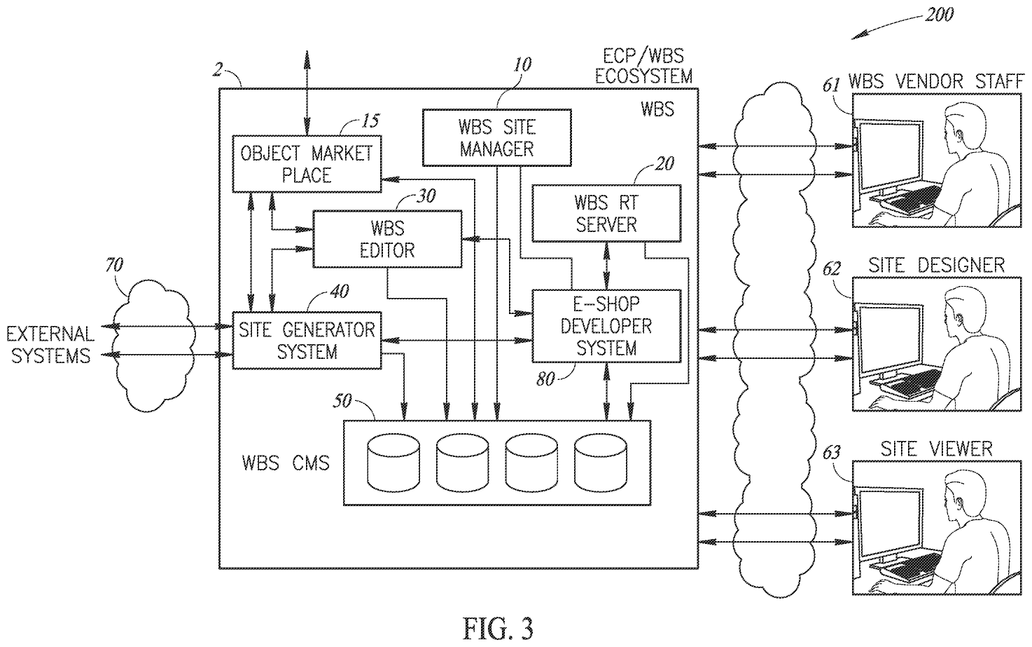

Reference is now made to FIG. 3 which illustrates such an ECP/WBS ecosystem 200 according to an embodiment of the present invention. ECP/WBS ecosystem 200 may further comprise the WBS 2 of FIG. 1 with an e-commerce platform such as an integrated e-shop developer system 80. It will be appreciated that in an alternative embodiment, e-shop developer system 80 may be associated externally with WBS 2 and not integrated. E-shop developer system 80 may be used to create multiple EPSs, present them, allow the merchant to select a relevant EPS, and quickly build an e-shop accordingly. This may include matching the appropriate set of presentation templates to display the EPSs. E-shop developer system 80 may further include a variety of tools that allow the manipulation of EPSs in various ways as described in more detail herein below.

It will be appreciated that in other embodiments, an ECP may be a stand-alone product, be integrated into/part of a WBS, be a larger system integrating a WBS within it or be a WBS-based site (possibly using a WBS language such as Velo provided by Wix.com, Ltd.). E-shop developer system 80 may also include WBS elements and dedicated code, include WBS elements and third party applications and may interface with external marketplaces or platforms to present e-shop (or specific e-shop pages or page elements) within their environment or be a combination of any of the above.

Thus, a merchant's e-shop may be (for example) hosted by the ECP environment, hosted within a large e-commerce provider (such as Amazon or eBay), with the ECP providing specific pages or page elements (e.g., through an iFrame or a web service), hosted by a third party hosting provider, with the ECP providing specific pages or page elements, directly hosted by the merchant (e.g., using the merchant's own server infrastructure) or be any combination of the above. These may include a combined hosting solution that separates customers based on geography, language, product set, customer type, organizational affiliation, technical customer platform (e.g., device or operating system (OS)), or other parameters.

It will be appreciated that discussion below is the context of a commercial e-shop. However, it is also applicable in a non-commercial setting or when otherwise customers are not being charged for their purchases. An example would be a website operated by a non-profit to distribute free goods for populations in need.

E-shop products may include physical products and goods (including printed products) or online or digital products (video, audio, books, non-fungible tokens (NFT) etc.). These may include downloadable or remotely accessed ones (e.g., streaming-based and video on demand).

Products may also include blockchain-based products, such as NFT and other assets or registrations residing in a blockchain or other online registration system (distributed or centralized), as well as tickets, reservations (e.g., hotels, flights, events, etc.), and subscriptions.

Products may further include services such as service sessions (which could be associated with a schedule or not). These could include online and off-line services, and services involving voice/video conference or other conferencing options. The services could be interactive or not (e.g., Webinars).

Other products may include remotely/locally produced products, e.g., print-on-demand goods, 3D printed goods, etc., virtual goods (inside games and game worlds, virtual reality (VR), augmented reality (AR) and other shared online environments. These may include, “non-movable” virtual goods, e.g., virtual real estate, “movable” virtual goods, e.g., game items and merchandize and virtual properties and capabilities, e.g., game characters capabilities.

Each product in an EPS may have product definition which may include multiple elements and attributes some visible to a customer and some not (e.g., only visible to the merchant). Such elements may include name, representative image(s) (also known as cover image(s)), price, brand name, model, and required customer properties (e.g., size XS, S, M, L, XL for clothing, shoe size number for shoes, age limitations for rated video content).

Other product definition elements may include color options, applicable taxation, regions of availability, additional metadata, descriptive/marketing text fields (about text, tag lines, short/long titles, description), technical specification and parameters (e.g., for a smartphone or a mountain bike) and physical size/weight (especially as required for shipping calculations).

Product definition elements may further include language(s) information (e.g., language use in products that include relevant language content such as text or audio), related products, shipping options, delivery options (e.g., print on demand), availability options/status (e.g., in stock, X available, open hours for services, etc.) as well as time to deliver (e.g., per delivery option), customer reviews, internal product ID/code, customer scoring, classifications (including taxonomy-based), categories, attributes, and tags and market fit information (e.g., adapted to geography X or customer types Y and Z). E-shop developer system 80 may have an external (merchant-specified/customer-visible) set of market fit information and a 2^{nd} internal (and more detailed) set of market fit information (which is not visible to customers).

It will be appreciated that a product may also have backend information (or other commercial metadata), such as information related to the product's vendor relationship, drop-shipping options, commercial engagement (and its terms), logistics-related information, etc.

The elements and attributes as described above may be specified by the product supplier, the shipper, the merchant, or even by customers (e.g., in the case of product reviews). In addition, some elements and attributes may be calculated by e-shop developer system 80 (e.g., related product recommendation) rather than pre-specified or separately stored data fields.

System 80 may support a multi-level override capability (e.g., a product can have an original manufacturer-specified name, a different name overriding it by a distributor, and a “final” name assigned by the e-shop owner) as discussed in more detail herein below.

It will be appreciated that the list of product elements and attributes above is not mandatory and that some products may have different subsets of the list above (or possibly additional fields).

Furthermore, different products may use different taxonomies or classification systems for the same data fields (or similar ones). Such different taxonomies could use different value spaces, e.g., shoes use a numerical size designation while pants use a S/M/L designation, or may have different meanings for values in the same value space, e.g., a shoe size 45 has a different meaning from a shirt size 45.

The discussion below describes multiple entities typically involved in ECP/WBS ecosystem 200, such as customers, merchants, suppliers, and technology vendors. Such entities may be a person, company, partnership, organization, non-profit, government, or other political or administrative entity (at any level), etc. An entity can also be “artificial” in the sense of being operated and directed based on artificial intelligence (AI)/machine learning (ML) technologies. Such an artificial entity could be, for example, an ML-based system interacting via a chatbot or other interfaces. An entity could also be semi-artificial, e.g., operating a UI (such as a chat interface) that is partially human-driven and partially AI-driven. An entity can also be composite, e.g., a person acting on behalf of a company.

It will be appreciated that a reference to one of these entity types (e.g., a person or a company) may also include all other entity types.

Regarding relevant players (i.e., participant categories) involved in system 200, the main players may include customers (end-users of the e-shop), merchants, suppliers, marketplace providers, catalog curators and WBS vendor staff.

Merchants may include the e-shop owner (who owns or controls the e-shop and its content) or the e-shop designer (who is responsible for technical and visual design of the e-shop). The owner and the e-shop designer may both be responsible for e-shop setup functionality, e-shop maintenance, and ongoing operation.

Suppliers may include vendors, distributers, original equipment manufacturers (OEMS), manufacturers etc.

Drop-shippers may include these include entities that fulfill orders, such as a “regular” drop-shipper, which maintains an inventory of specific items (or suppliers), logistics services providers (such as warehouses and shipping companies), local fulfilling agencies, such as local print-on-demand shops, 3D printing services, etc.

Drop shippers may also be marketplace providers, companies which concentrate a large number of suppliers (such as the AliExpress website owned by the Alibaba Group in China) and customer clubs which offer deals to their members).

They also may be catalog curators, persons who create and maintain curated catalogs containing multiple products (such as EPSs). These could be WBS vendor staff 61, merchants, vendors, independent curators, or any other category of persons. These are also known as visual catalog curators or catalog designers. It will be appreciated that WBS vendor staff 61 include all staff involved in the WBS development and its deployment and operation.

It will be further appreciated that there may be an overlap between player types. For example, a supplier may also provide logistics or drop shipping services. In addition, a user could be a customer in one area and a merchant in another area.

Another player may be a user of the system 80 in general, encompassing multiple categories from the list above. Any of the above players may be direct users of system 80 or may use separate systems, which may be connected to system 80. Each of these players can be of any entity type noted above (a person, a company, a partnership, etc.)

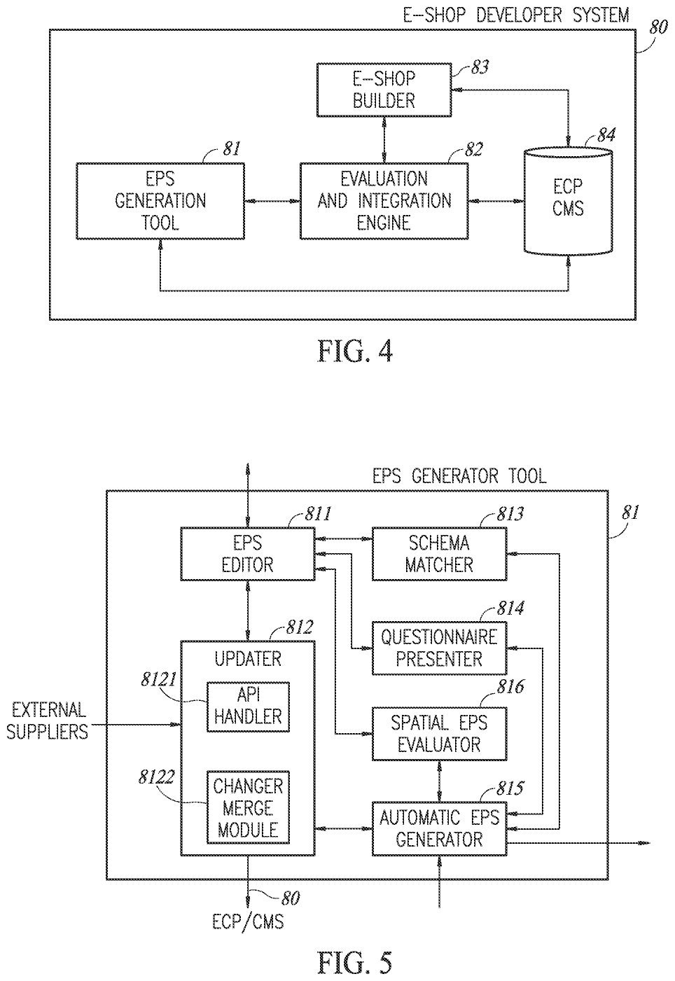

Reference is now made to FIG. 4 which illustrates the elements of e-shop developer system 80. E-shop developer system 80 may further include an EPS generator tool 81, an evaluation and integration engine 82, an e-shop builder 83 and an ECP content management system (CMS) 84.

EPS generator tool 81 may provide both manual editing services for a catalog curator to create his EPSs and automatic EPS creation. Evaluation and Integration engine 82 may provide data gathering, data analysis and machine learning support for both EPS generator tool 81 and e-shop builder 83. E-shop builder 83 may enable a user of WBS 2 to create an e-shop quickly and efficiently using created EPSs. ECP CMS 84 may store data pertaining to the creation and use of EPSs. The function of these elements is described in more detail herein below.

It will be appreciated that CMS 50 may store website definitions such as pages, components, attributes (type, colors, position, size, transparency etc. as well as WBS user and site information. ECP CMS 84 may store e-commerce information such as catalogs, products, sales information and site designer information such as user experience, geography, user type (pro, agency, regular, . . . ) as well as website editing history, website content (including media data, such as text, image, video, audio, spatial, 3D and other data). ECP CMS 84 may also store site user information such as—geography, pages viewed, action taken in site and business information together with site e-commerce information such as product viewer information, purchased information, fulfillment information, price paid and payment methods. It will be appreciated that there may be an overlap between information stored by CMS 50 and ECP CMS 84.

In an alternative embodiment, EPS generator tool 81 may be a stand-alone part of system 200 (with its own UI), a UI integrated into the ECP backend or other data management UI or a UI integrated into a general ECP template construction tool.

It will be appreciated that the e-shop discussed below is described through an embodiment implementing it as a website built using WBS 2. In alternative embodiments, additional embodiments may be used, such as mobile sites, mobile applications, stand-alone devices (such as a data kiosk or a specialized desktop or mobile device), distributed or client-server system, attached device (e.g., a restaurant menu display device operating with a restaurant point of sale (POS)), an element within a larger hardware or software system (e.g., a module within an organization's operational system), or a combination of any of these embodiments.

It will be appreciated that a virtual e-shop may also be implemented or hosted within an immersive or semi-immersive environment (such as an augmented reality (AR) or virtual reality (VR) environment). Such a virtual e-shop may emulate a real-life shop.

As discussed here in above, system 80 may be embedded within or otherwise integrated with WBS 2. Thus WBS 2 may be used to create a website containing the generated e-shop and may also host websites for other users (merchants or otherwise).

It will be appreciated that there are multiple integration points and interfaces between WBS 2 and system 80 generally aimed at allowing the merchant to create an e-shop site without having to use WBS editor 30. The integration of system 80 with multiple WBS 2 services and verticals may provide additional services and vertical applications, such as bookings, blogs, events, etc.

System 200 may use collected BI (business information) from various services and verticals to provide better results (recommended products, EPSs, and EPS sets) for the e-shop creation.

For example, system 200 may select EPSs to offer based on the information on orders in a booking application. Specifically, system 200 may offer catalogs to the above mentioned yoga trainer chosen based on the types or styles of yoga most popular among the members of his yoga gym (based on the actual booked sessions).

System 80 may be integrated with the underlying template repository of WBS 2 (part of WBS CMS 50). Thus, the template repository may offer “regular” e-shop templates (containing dummy product definitions) side by side with functional e-shop templates. It will be appreciated that functional e-shop templates may contain actual products with backend/fulfillment/drop-shipping information with display and related attributes. Such functional e-shop templates may be actual pre-generated functional templates, or may be dynamically generated (by EPS generator tool 81) for the designer based on the designer's current parameters at the time.

Alternatively, EPS selection and template association elements may be integrated with or otherwise operable through WBS editor 30. Such integration may allow an e-shop to be created and/or edited in conjunction with the editing of the rest of the website.

As described above, WBS 2 may include an SGS (site generation system) 40 that allows automatic generation of a website from content elements (CEs) displayed through matching layout elements (LEs). This generation is done based on questionnaires and collected data (for the user and from possible external sources). System 80 may be integrated with SGS 40, so the created e-shop becomes one of the generated website sections.

In this scenario, the EPS selection process and the template association process would be part of the site generation process. The product details would be regarded as CEs, and the associated product display templates as LEs.

It will be appreciated that such integration may allow system 200 to use non-conventional layouts and organizations. For example, system 200 may support layouts in which the offered products are displayed in multiple areas of the page (with other elements interspersed between them) and not only together in a single catalog display screen area.

System 200 may also insert additional content in the created e-shop. This content insertion would typically be at the e-shop level (e.g., “About Us” text or background images) rather than the specific product level. Such inserted content is usually subject to the e-shop designer's approval or editing. It may be marked as “subject to review” (e.g., requiring the marking to be removed before e-shop publishing). The inserted content could be specific to the parameters of the e-shop and its products. For example, system 200 may add images of high-quality apartment designs as background images to a floor tiles e-shop. Such inserted content could be selected (using e-shop parameters and possibly randomization) to the generated e-shop.

SGS 40 may also support such a process by providing appropriate repositories of relevant content and the means to specify parameters for the selection of relevant content. Such means may include APIs, web services, or additional invokable UI elements (such as questionnaires). These means may allow SGS 40 to identify information related to the business, the industry and other parameters related to the e-shop.

Reference is now made to FIG. 5 which illustrates the elements of EPS generator tool 81. EPS generator tool 81 may comprise an EPS editor 811, an updater 812, a schema matcher 813, a questionnaire presenter 814 and an automatic EPS generator 815 and a spatial EPS evaluator 816. Updater 812 may further comprise an API handler 8121 and a change merge module 8122. The functionality of these elements is described in more detail herein below.

EPS editor 811 may enable manual creation and editing of EPSs, updater 812 may handle manual and automatic updates to products and their attributes etc. from different sources. Schema matcher 813 may map between the supplier product information schema and the system 80 schema. Questionnaire presenter 814 may present and receive input back from questionnaires presented to a curator or merchant to help create an EPS both manually and automatically and automatic EPS generator 815 may create automatic EPS s according to information from the other elements within EPS generator tool 81 and from recommendations provided by evaluation and integration engine 82.

It will be appreciated that EPS s may have additional characteristics in addition to the characteristics described herein above (i.e., being functional and harmonious). Spatial EPS evaluator 816 may take into account some or all of the following characteristics when creating and editing EPSs.

Spatial EPS evaluator 816 may evaluate completeness, i.e., that EPSs are optimized towards fulfilling the complete (as much as possible) set of requirements of a specific customer group.

Spatial EPS evaluator 816 may also evaluate diversity, i.e., that EPSs are optimized towards including a set of products having the maximal variety between them (e.g., defined using a distance metric between feature vectors representing features of the included products).

Spatial EPS evaluator 816 may also evaluate fulfillment optimization, i.e., that EPSs are optimized towards improving fulfillment parameters (cost, time, availability, order size, product quality, or other parameters). This could be done, for example, by minimizing the number of suppliers, or by balancing between availability and delivery time.

It will be appreciated that since an EPS may include a non-static set of products, its dynamic availabilities may be taken into account when allowing the catalog curator to modify the EPS and create updated versions.

It will also be appreciated that functional side of the EPS (i.e., the integration with drop-shipper or other fulfillment service provider) may be implemented a number of ways (or as a combination of), such as:

The catalog curator may pre-associate the entire EPS or specific products with drop-shippers (including using multiple drop-shippers for different products).

The catalog curator may pre-associate the specific products with multiple drop-shippers, allowing the using merchants (or follow-up logic) to select the right drop-shipper to use. For example, the same EPS may be used by merchants in different countries. These merchants may benefit from using different drop-shippers.

The catalog curator could also mark specific products with drop-shippers selection parameters, and let the merchant perform the final selection when implementing the EPS.

EPSs may also have additional parameters and attributes. EPSs may have attributes matching some of the product attributes described above (e.g., name, description, classification/categories, tags, etc.). It will be appreciated that some product attributes may not be relevant to an EPS.

EPSs may also have attributes that generalize attributes of an included products. For example, an EPS may be generalized as “color=red” if it contains clothing products in various shades of red.

EPSs may have additional per-product attributes which are separate from the stand-alone product attribute. For example, the EPS may have an “active” attribute for each product in the EPS, allowing products to be included in the EPS on a non-active basis (i.e., without actually being offered right now).

EPSs may also have price-related attributes. This could be (for example) a simple price for the use of the EPS (e.g., pay $X to use this EPS, or pay $Y for each update). Such an attribute could be a smart-contract type pricing scheme per time period, per sale of products from the catalog or have pricing dependent on customer type, geography, or have other attributes.

EPSs may have merchant-related attributes. These attributes may provide additional information on EPS suitability to specific merchants. These attributes may be at the entire EPS level or applied to specific products in the EPS. Such attributes may, for example, specify that the EPS is aimed at merchants from specific geographics, or having a specific size (e.g., in terms of sales volume or typical order size), or otherwise having specific attributes.

Such attributes may be mandatory (e.g., strictly limit this EPS to merchants from country X) or may be optional (i.e., allow a merchant to bypass them and still use the EPS, even if the merchant doesn't match the requirements). These attributes may also provide information on how to adapt the EPS to a specific merchant. A given EPS may serve multiple (typically related) merchant types, and these attributes may guide the system in adapting the EPS based on the specific merchant type.

These attributes may also include system 200 related parameters used to provide a different user experience to the merchant or the customer in interacting with the EPS. These could be, for example, customized browsing UI. These attributes could also include information about the presented order, layout, or template selection for the EPS and product-level UIs.

It will be appreciated that all these additional attributes may be defined using EPS editor 811 and the data may be used by evaluation and integration engine 82 to match and adapt the EPS to the merchant as described in more detail herein below. However, they are not used (and may not be visible) to the merchant/e-shop designer when previewing, selecting, and using the EPS in an e-shop.

It will further be appreciated that both EPS editor 811 and automatic EPS generator 815 may be separate from general presentation templates editing, which may be done (for example) using template editing tools available in WBS 2. In an alternative embodiment, the two functions may be integrated within a single editing framework.

EPS editor 811 may be used to add and remove products from the EPS and to edit product attributes, possibly assigning EPS-specific values. For example, EPS editor 811 may be used to rename a product to give it a more relevant or otherwise beneficial name. This name could be different from the original provider's name given to the product (vendor or drop-shipper). The same may apply to overriding other product attributes (e.g., overriding video content age limitations to reflect different local regulations). It will be appreciated that system 80 may offer similar overriding capabilities at additional system levels, e.g., allowing a merchant further to override product properties in the merchant's e-shop.

EPS editor 811 may also be used for editing of EPS attributes, for merging of EPS s and for duplicate product elimination or reduction including the elimination of identical products, as well as locating similar products and recommending a smaller subset. The latter can be done, for example, by performing a multi-dimensional cluster analysis of the products set (in a multi-dimensional space based on evaluation and integration engine 82 scores or product attributes). EPS editor 811 may detect “small enough” clusters and select relevant products from these clusters, thereby reducing redundancy in the edited EPS.

EPS editor 811 may further be used to manage the EPS collection, i.e., it could be used (for example) by the WBS vendor staff (to manage the entire set of EPSs) and individual catalog curators to manage their own set of EPSs.

EPS editor 811 may enable catalog curators to select high-quality sets of products and generate one or more EPSs. In addition, the e-shop builder (used by the merchant) may use such EPSs to populate an e-shop quickly. Although these are typically separate elements of system 80, many of the EPS editor functions described herein may be included in e-shop builder 83 as well as discussed in more detail herein below.

For example, a merchant may use the e-shop builder to include multiple EPSs in their e-shop and benefit from smart merging capability, which provides for duplicate or near-duplicate elimination.

As discussed herein above, EPSs may be dynamic. The catalog curator may modify the EPS occasionally, even after the EPS has been selected for use by one or more merchants. The “clients” of the EPS (e.g., merchants incorporating the EPS in their e-shops) may take a snapshot (i.e., a frozen version) of the EPS or may subscribe to receive updates to the dynamic EPS.

Updater 812 may handle these updates using, for example, via a change propagation mechanism or an inheritance-like mechanism. Updater 812 may also ensure that all e-shops within the WBS that are using the same EPS are also updated automatically as described in more detail herein below.

API handler 8121 may provide a direct link to communicate with a supplier to receive fulfillment and product update information for a particular product and may update the EPS accordingly. This may be though an API (application programming interface), an SPI (service provider interface), a web services based connection or any type of system to system communication. API handler 8121 may also handle connections to drop shippers and other providers of products.

It will be appreciated that a merchant may also create local modifications to an EPS. In such a case, change merge module 8122 may manage the merging of EPS updates with changes performed by the EPS-using merchant. Change merge module 8122 may be automatic, rule-based, or allow for merchant notification (with the merchant resolving cases that can't be automatically resolved).

It will be appreciated that in the discussion below, EPSs are typically referred to as persistent objects (generated by a person or automatically via automatic EPS generator 815 as described in more detail herein below).

However, different embodiments may also support virtual EPSs, which are generated on-demand. Such virtual EPSs may be generated based on the general parameters detailed below (e.g., information about the products, merchants, sales, customers, etc.). In addition, they may also be generated based on specific parameters for virtual EPSs specified by a catalog curator (e.g., create on-demand a winter collection and a summer collection).

It will be appreciated that different embodiments of the inventive system may also support a mixture of persistent EPSs and virtual EPSs (with specified parameters or not).

It will be appreciated that the product schema used by system 80 may differ from that used by the various suppliers, vendors, and drop-shippers, even for identical products or products of the same category. For example, multiple suppliers may have different sets of product descriptions (name, about, short description, detailed description etc.).

In these cases, schema matcher 813 may perform the mapping between the supplier product information schema and the system 80 schema (which may or may not be a superset of the suppliers' different schemas).

In particular, the mapping may involve not just matching between different fields sets but also performing transformations between the data fields provided by the suppliers and those defined by system 80.

The matching and the transformation can be predefined at a number of levels or stages. In particular, they may be defined by whoever creates the interface to the supplier, this could be the WBS vendor staff 61, the catalog curator, or even the merchant (if they are allowed to create such interfaces). Alternatively, schema matcher 813 may provide some or all of the matching and transformation. schema matcher 813 may analyze the supplier's schema, detecting the relevant fields (product name, description, cover image, etc.), matching them with the system's internal schema, and detecting the required transformation. Schema matcher 813 may also have a fallback in case some essential fields are not matched. Schema matcher 813 may further analyze the content of the fields (on the supplier side) to better detect and understand supplier information (e.g., the supplier information could be incorrect or too generally described) and may amend or correlate such supplier information which requires modification.

As discussed herein above, an EPS is functional, i.e., it includes association with drop-shippers (or other suppliers) which make the EPS operation “right out of the box.” Some embodiments may require the entire EPS to be functional, while some may allow products to be included in the EPS without a backend fulfillment relationship. In addition, some embodiments may require all products in the EPS to use a single supplier (drop-shipper or vendor), whereas other embodiments allow EPS products to be associated with multiple suppliers.

EPSs may also include information related to the association with presentation templates. This information allows for the best matching to be performed for display, as discussed in more detail herein below.

It will be appreciated that references to “catalog” (in general) in the context of the inventive system may also refer to EPSs in the discussion below.

As discussed herein above, EPS s may be generated automatically or manually. There are a number of categories of people (or other entities) that may be involved in EPS creation (both automatic and manual). These may include system 80 vendor staff creating EPSs for use within system 80 such as WBS vendor staff 61 or separate users, professional catalog curators, suppliers of all types (e.g., merchant, vendors, drop-shippers) can build EPSs based on their offerings (e.g., “Our winter collection”) and possibly additional products from different suppliers.

Thus, EPS handling could be multi-tiered, i.e., a “higher-level” merchant may create EPSs used by “lower-level” merchants to fill their e-shop. Furthermore, a non-merchant catalog curator can create a branded EPS and make it available to merchants, including setting a price as noted above. Such branded catalogs may be useful, for example, for a celebrity-branded EPS, especially in conjunction with dynamic EPSs as described herein above.

For example, a famous athlete could offer a branded EPS for products related to his branch of sport and could also publish a seasonal update to the EPS. The athlete could set a charging scheme for the merchant using the athlete's catalog and its update. Such charging could include smart-contract style charging (as described herein above).

It will be appreciated that in the discussion herein, sets of EPSs may be referred to as “flat” collections (of multiple co-equal EPSs). However, different embodiments may use different methods to organize the EPSs, such as hierarchies (possibly implementing inheritance relationships), networks, or other possible organizations.

Automatic EPS generator 815 may be used by catalog curators (for pre-generated catalogs) or by e-shop creators (for dynamically generating a catalog when required). Automatic EPS generator 815 may use information derived from questionnaire presenter 814 and recommendations from evaluation and integration engine 82 to automatically create an EPS accordingly. Automatic EPS generator 815 may further update and regenerate an EPS according to updates received by updater 812.

System 80 may further provide questionnaires that allow its users to provide additional parameters and information. For example, questionnaire presenter 814 may present a questionnaire to the catalog curator to gather additional information to guide the EPS editing and product selection. The questionnaires may be manually created or autogenerated using information from CMS 50 and ECP CMS as described in U.S. Pat. No. 10,073,923.

Questionnaire presenter 814 may similarly present a questionnaire to the catalog curator to provide parameters for the generation of the EPS. Questionnaire presenter 814 may also allow the catalog curator to attach a questionnaire to an EPS and associate actions (such as filtering of data or ECP events and triggers) to the questionnaire and specific responses provided through the questionnaire and actions performed by the merchant using it. Evaluation and integration engine 82 may analyze responses to the questionnaires as discussed in more detail herein below.

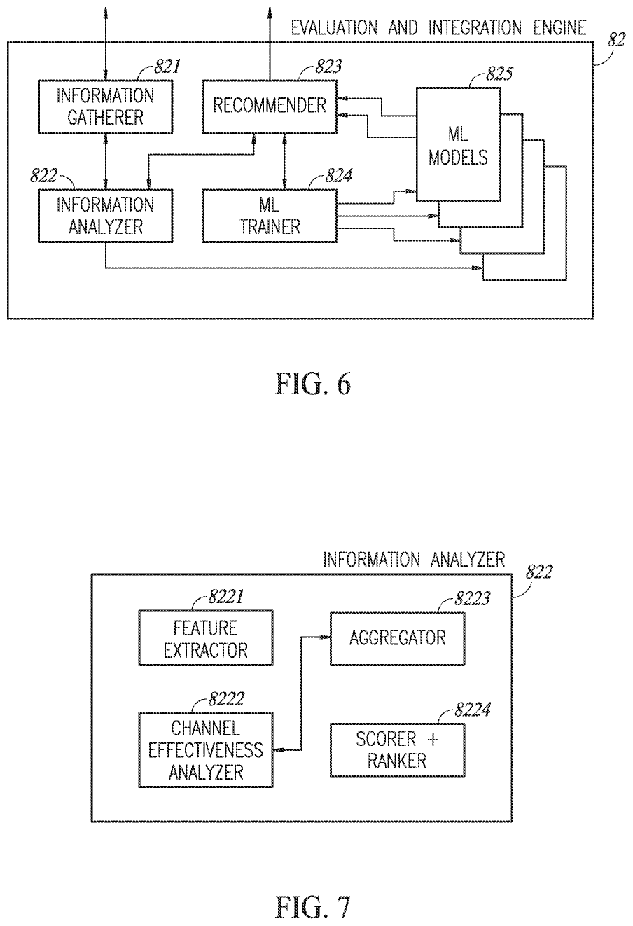

Reference is now made to FIG. 6 which illustrates the elements of evaluation and integration engine 82. Evaluation and integration engine 82 may further comprise an information gatherer 821, an information analyzer 822, a recommender 823, a ML trainer 824 and multiple ML models 825.

It will be appreciated that EPS editor 811 and automatic EPS generator 815 may make use of evaluation and integration engine 82. Evaluation and integration engine 82, in general, may perform data gathering and generation of metrics, ML feature vectors, and derived information based on the gathered data and make recommendations accordingly. ML trainer 824 may use gathered feature vectors to train the relevant underlying ML models 825, as well as for follow-up operation of these models. Evaluation and integration engine 82 may combine the gathered data to produce further results as described herein below.

Information gatherer 821 may gather information when required. It may use system data repositories such as WBS CMS 50 and ECP CMS 84 which are updated continuously and extract the information when required. Alternatively, information gatherer 821 may interface with external monitoring or data collection systems.

Information gatherer 821 may collect attributes of current and potential players (as defined above), e.g., customers, merchants, suppliers, drop-shippers, etc., attributes of products and product collections including EPSs and other product collections inside and outside the system as well as specific EPS property evaluation, such as completeness, diversity, and fulfillment optimization, as discussed herein above.

Information gatherer 821 may also gather operational information related to the various players (merchants or otherwise), such as purchasing and sales information, pricing information, company business information, etc. as well as business environment information, such as information about shipping, taxation, regulations, etc.

Other information gathered may be accumulated information related to performance and fit of products and EPSs to the merchant and customers using them, e.g., how well a given EPS product was sold, how well merchants selected a given EPS, etc. as well as responses to questionnaires provided to the user (catalog curator, merchant, etc.) in conjunction via questionnaire presenter 814.

Information gatherer 821 may also gather information related to the merchant's website or e-shop, including updates, changes, editing history and gathered BI information. This information may be gathered from the underlying WBS CMS 50 and ECP CMS 84. It may also gather information Information extracted from other data sources related to the merchant himself (such as other websites belonging to the merchant, merchant social media presence etc.)

It will be appreciated that information gatherer 821 may also gather information related to activity by other users or persons (who are not the catalog curator), which may be highly relevant to system 200. For example, evaluation and integration engine 82 may evaluate if a given EPS was successful based on information from other users. This information could be at the catalog curator level (e.g., how many merchants chose this EPS) or at the merchant level (e.g., did the EPS attract customers and produced improved commercial results).

Such gathering may include users within the ECP ecosystem (e.g., customers, merchants, and suppliers using the ECP) and users outside the ECP ecosystem (e.g., in separate e-shops or other websites). Information analyzer 822 may correlate the two types of population, e.g., using detailed statistics available inside the ECP ecosystem to better analyze and extrapolate from information gathered outside the ECP ecosystem. This correlation could help system 200 analyze (for example) visitor conversion rates and buying patterns and provide effective recommendations based on this analysis.

Such gathering may also include non-user-specific sources, such as industry-standard databases, business directories, or various web services.

Such gathering may further include information extracted from off-line sources related to the user, e.g., manually provided by the WBS personnel or extracted from off-line documentation.

It will be appreciated that gathering of external information should be made subject to the relevant laws and regulations, including support for users' privacy, anonymity, and intellectual property rights (such as copyright and trademark laws) governing use of such information.

Information analyzer 822 may analyze the gathered data by information gatherer 821 to provide information for use by recommender 823 and ML models 825.

Recommender 823 may provide recommendations for both the creation of EPSs (manual and automatic) and their use in the creation of an e-shop by e-shop builder 83 as described in more detail herein below. Recommender 823 may (for example) only provide suggestions based on statistical summarizing of multiple users and only in cases where a sufficiently large number of users can be analyzed. Evaluation and integration engine 82 may further use techniques from the area of statistical databases security. Furthermore, limiting the use of sensitive extracted information to mapped feature vectors (used for ML engine training) may provide an additional layer of privacy.

Reference is now made to FIG. 7 which illustrate the sub elements of information analyzer 822. Information analyzer 822 may further comprise a feature extractor 8221, a channel effectiveness analyzer 8222, an aggregator 8223 and a scorer and ranker 8224.

It will be appreciated that information analyzer 822 may analyze gathered data over the entire user population or may analyze attributes of segments of the user population (according to user's location, industry, type, age in the system, experience level, e-shop size and sales business volume, typical order parameters (size, quality, speed of response, etc.), available shipping methods, or other parameters).

In particular, information analyzer 822 may focus on users whose businesses are similar to that of the user. Such use of gathered information may be limited to cases in which a sufficiently large community (or sub-community) can be analyzed so to provide significance to the data on the one hand and sufficient privacy to individual users' answers on the other hand.

Aggregator 8223 may gather and aggregate e-commerce related information and operational data. Such data may include data at the merchant level (e.g., similar merchants) or the product level (e.g., similar products carried by other merchants).

Such operational data gathering and analysis may include (for example) conversion rates (i.e., percentage of visitors who become paying customers), cart abandonment rates, user behavior within the e-shop (e.g., browsing behavior, time to purchase, other products browsed, etc.) and channel-specific data, per channel sales volume information, fee structure and channel-specific advertising platform parameters.

Channel effectiveness analyzer 8222 may use aggregator 8223 information to determine channel effectiveness. Different channels may have different fee structures, different sales volumes generated, and different advertising platforms. Thus, channel effectiveness analyzer 8222 may compare investment in advertising and marketing in a given platform (e.g., through its associated advertising platform) to other platforms, as well as the ECP's own data.

For example, a large (and possibly expensive) platform (such as Amazon commercially available from Amazon.com Inc.) may provide higher potential sales volume but with higher fees and advertising costs. This should be compared to a lower-profile platform (or independent hosting) which may offer lower sales volume but with better margins and lower advertising costs.

Such analysis may be especially relevant in cases in which there are limitations on product availability (due to manufacturing, shipping, supplier rationing, or other fulfillment issues). The analysis is also relevant when determining where to allocate advertising budgets (which are inherently limited).

Information analyzer 822 may predict some of the metrics above (such as conversion rate, cart abandonment, etc.) for expected ECP-based deployment.

It will be appreciated that information analyzer 822 may compare the performance and the parameters of the product sales to the same or parallel products sold through the ECP. Based on this data, ML trainer 824 may train an ML model 825 to forecast the performance parameters of products in the ECP based on derived data for other systems. Such analysis and training can be done at a single product level or the product set level (e.g., how well a given product set X would sell on the ECP based on information on member products A, B, and C from multiple sources). Of course, any such analysis should be made subject to the relevant laws and regulations, privacy, anonymity, and other rights as described herein above.

Information analyzer 822 may also provide targeting results, i.e., for an ECP that can be used through multiple channels (e.g., for stand-alone e-shop combined with Amazon-integrated offering). The analysis may further recommend the best way to divide products, and marketing budgets between the platforms and channels.

As discussed herein above, the sub elements of evaluation and integration engine 82 may provide information and functionality to EPS generator tool 81 and e-shop builder 83. Functionality may include the creation of feature vectors by feature extractor 8221 which may be used especially for the training of ML models 825 by ML trainer 824 as described in more detail herein below. The feature vectors may also be used for the later running of these models, as well as for use within EPS generator tool 81.

Feature extractor 8221 can be used to extract feature data from multiple data types and sources in system 80 and create vectors. These feature vectors are used when training the various ML models 825. The extracted features may be represented as vectors, tensors, or other forms (such as image to image feature extraction). Feature extractor 8221 may handle the different data types as stored by CMS 50 and ECP CMS 84 as described herein above.

It will be appreciated that feature extractor 8221 may use its own underlying ML models 825 to perform the feature extraction as described in more detail herein below.

In particular, feature extractor 8221 may use transformers, fully connected layers, and other AI methods (as discussed herein below) to embed (encode) users, products, product collections, and other system entities. Such embedding can be made into a description space, multiple description spaces or latent spaces. In these spaces the embedded entities may be more easily compared, associated, or otherwise have relations identified and quantified.

ML models 825 may further implement contrastive methods, graph neural networks, energy-based methods (e.g., for inference-time optimization), multi-modal feature extraction (for image and text content)

Feature extractor 8221 may also include a regression or classification layer whose output may or may not be used in the final feature extraction output.

Feature extractor 8221 may further use representation learning by training models to perform as feature extraction for tasks different than the ones used during training time

Scorer and ranker 8224 may provide scores for the different stages and elements of system 80 i.e., for EPS construction, EPS shop construction using EPSs and shop access by end user.

For example, scorer and ranker 8224 may provide a score for a given product relative to a currently built EPS (in terms of fit quality, completeness, diversity, fulfillment optimization, etc.) Another example would be the rating of potential marketing channels or drop-shippers for a given product. There may be multiple such scores for a given element in some cases, and thus the rating process may be multi-dimensional. Scorer and ranker 8224 may integrate these results into one or more combined scores. Scorer and ranker 8224 may also use a combination of methods, including static analysis of the underlying entities and information available in the system (e.g., details and properties of users and end-users), using an embedded set of ML models 825 trained based on information gathered on actual user and end-user activity and selections, and system use patterns.

Scorer and ranker 8224 may also provide collection scores. This may be applied to a collection of elements, such as an EPS. Examples would include a diversity or completeness score for an EPS, helping the catalog curator when manually editing an EPS.

Recommender 823 may provide recommendations for elements or collections. Recommender 823 may recommend the next best (complementary) product to select for a given EPS being edited and recommend specific attribute values (e.g., product name or description) for both the catalog curator and merchant. These recommendations apply to cases in the system where the users (e.g., the catalog curator) have to provide attribute value for any objects. A similar use case may apply when providing answers to system questionnaires.

Recommender 823 may also recommend a set of EPS s to select from to offer the merchant when building his e-shop. It will be appreciated that this may help the merchant find the best EPS for his needs. These recommendations may be based on the merchant's e-shop location/geography, type, current business information, customer information, and other parameters, as discussed in more detail herein below.

It will be appreciated that the recommendations may be made for a catalog curator (which may edit the results to create a final set of EPS s) within EPS generator tool 81 or for a merchant (which will select the suitable EPS to use for their e-shop) using e-shop builder 83.

As discussed herein above, system 200 and its elements may make use of multiple ML models 825, e.g., for product evaluation and selection, catalog generation, catalog and catalog set offering, analysis, recommendation generating, matching, transformation, and other needs.

ML trainer 824 may train different ML models 825 for different needs and different ML-based engines. In addition, ML trainer 824 may generate new models (based on gathered training data) and may evaluate their performance against the existing models. The training data may include any of the gathered information from information gatherer 821 and information on actions performed based on the various recommendations by recommender 823.

It will be appreciated that an ML model 825 may be any suitable model for the task or activity implemented by evaluation and integration engine 82. Machine learning models are known in the art and typically use some form of neural network. The term ML refers to the ability of systems to recognize patterns based on existing algorithms and data sets to provide solution concepts. Up to certain limits, the more they are trained, the greater knowledge they develop.

The underlying ML models 825 may be learning models, including those which are supervised, self-supervised, semi-supervised, or unsupervised. As examples, such algorithms may be prediction algorithms, regression (e.g., linear regression, AdaBoost) algorithms, classification (e.g., decision trees, k-nearest neighbors, SVM) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders) or Generative models (e.g., GANs, DDPMs).

Alternatively, ML models 825 may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or auto-encoders) used to generate EPS definitions and elements.

For most embodiments, ML models 825 may undergo a training or learning phase by ML trainer 824 before they are released into a production or runtime phase or begin operation with models from existing systems or models. During a training or learning phase, ML models 825 may be tuned to focus on specific variables, reduce error margins, or otherwise optimize their performance or improvement rate. ML models 825 may initially receive input from a wide variety of data, such as the gathered data from information gatherer 821 as described herein above.

In another embodiment and when appropriate for the particular task, one or more of the ML models 825 may be implemented with rule-based systems, such as an expert system or a hybrid intelligent system that incorporates multiple AI techniques. These are discussed in the articles in the Wikipedia articles entitled “Rule-Based System” and “Hybrid Intelligent System”, at en.wikipedia.com.

As discussed herein above, the merchant can select an EPS to start the e-shop building process quickly. The merchant may also select multiple EPSs, combine their content, and otherwise edit the resulting product set (e.g., eliminating duplicative products, adding or remove specific products, etc.)

The merchant may also search for products and catalogs via categories, tags, or based on parameters they may provide (through a questionnaire or otherwise and may select display template(s) for use with the selected product set.

It will be appreciated that setting up an e-shop requires handling the visual and layout side of the e-shop. A selected EPS may provide the necessary product selection and associated backend information (fulfillment/drop-shipping, logistics, etc.). However, the EPS typically does not include presentation and layout information required to display the EPS and its constituent products (though it may contain explicit hints related to the display layout selection).

System 200 may display an EPS using display templates, which may be defined (e.g., through WBS editor 30 or other tools) similar to WBS page and page section templates.

An EPS may be displayed using a single display template for all products. An EPS may also be displayed using multiple templates, e.g., using different template types for different products.

In particular, different products may have different data fields associated with them. Furthermore, some templates may require specific fields, while other templates do not require the same fields, even when used with the same product or product type.

E-shop builder 83 may support a mapping facility, which allows the merchant to create, edit and manage such mapping definitions between product fields and display template fields. The mapping may include direct mapping and mapping involving combinations of multiple fields, calculations, or operative logic based on fields, or other mechanisms. The catalog curator may help this process by including hints and metadata with the EPS, which support later template association and data mapping by the merchant.

For a merchant setting up an e-shop, the typical workflow would be selecting an EPS, selecting one or more templates, and associating (connecting) the catalog and the templates. As discussed in more detail herein below, system 80 may offer a variety of ways in which templates can be automatically associated with the different products.

E-shop builder 83 may allow the merchant to quickly select the best template(s) (or have them provided automatically). This way, an e-shop, even one with an extensive catalog may be set up quickly.

E-shop builder 83 may provide tools allowing customization of the selected templates. This customization may affect template composition (e.g., included components), design, and layouts. It may include additional design elements, such as selection and adaptation of design kits (providing color palettes, font selection and other visual elements).

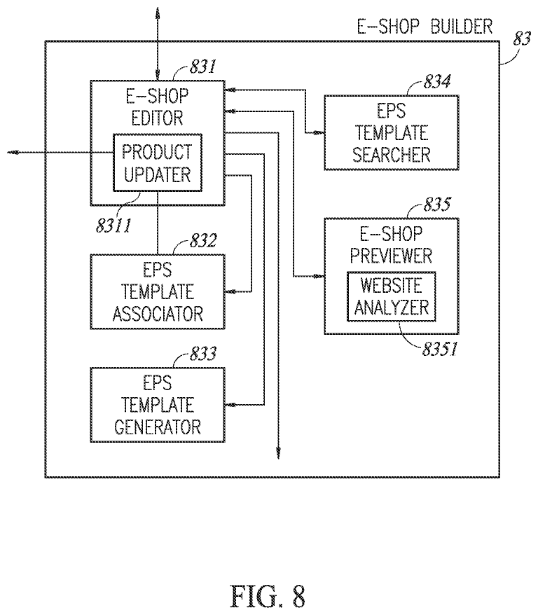

Reference is now made to FIG. 8 which illustrates the elements of e-shop builder 83. E-shop builder 83 may comprise an e-shop editor 831, an EPS template associator 832, an EPS template generator 833, an EPS template searcher 834 and an e-shop previewer 835. E-shop editor 831 may further comprise a product updater 8311 to receive manual product updates from the merchant and to update related EPSs including the product accordingly. E-shop previewer 835 may comprise a web site analyzer 8351.

E-shop editor 831 may provide an interface between the merchant and system 200 in order to select and edit EPSs, EPS template associator 832 may use pre-associations to find templates for display, EPS template generator 833 may generate at runtime a suitable template for display, EPS template searcher 834 may search in template repositories and provide automatic template construction, or use hybrid methods (e.g., combining pre-associated templates with additional constructed elements). E-shop previewer 835 may provide a preview of the e-shop being built before it is published.

As discussed herein above, an e-shop is often added to an existing website. System 200 may support templates that adapt to the website in which they are included. Thus, a template definition may include parameters specified by or inherited from the containing website. Such parameters may include color palettes, font sets, sub-element definition (e.g., select sub-element variation based on containing site), layout parameters, or other template elements.

EPS template associator 832 may pre-associate a display template (or multiple templates) with given products or product types (based on attributes of the products). Examples may include associating a display template with shoes in general or multiple templates with different shoe types (sport, dance, walking, regular, etc.).

EPS template associator 832 may also associate or locate (via a search) multiple display templates and select one based on context/working mode (e.g., catalog display mode vs. single product display mode), user type, screen size/display area, keyword match (template vs. product details), etc.

EPS template associator 832 may further select display templates based on field matching, i.e., selecting the display template whose fields most closely match the fields that should be displayed from the product information. Such templates would typically be the ones most suitable to the EPS and the products included in it.

EPS template associator 832 may also use tree-structured or inheritance-based display template set definitions which may fall back to parent definitions when needed (e.g., if a display template matching “Polo shirt” is not available, fall back to the parent template for “Shirt”).

EPS template generator 833 may generate display templates “on the fly” based on relevant fields in the product definition. This could be done based on rules or “generic templates” defining how fields would be placed (used rather than an actual fully detailed template).

EPS template searcher 834 may use integrated template searching and dynamic construction to locate a matching template that is pre-associated and may add required additional fields (e.g., using dedicated “landing zones” to allocate screen space for additional data fields area). It may also amend the matching template by re-arranging fields, removing fields etc.

It will be appreciated that the WBS vendor staff 61 or other template designers or system users may define roles for specific fields, e.g., a “product name” role or a “cover image” role, and possibly specific additional attributes to these roles (e.g., “only use this [product name] role field is the name has less than 50 characters). Multiple fields can have the same role (e.g., the template designer wants the product name to display at both the top and bottom of the displayed page).

EPS template associator 832 may use these roles to support template association and product data insertion processes, rather than just using existing fields information.

These methods are described in detail in US Patent Publication No. US 2014/0282218 with the use of list application data items parallel to products and list application views parallel to product display templates.

It will be appreciated that the processes described herein above may also be re-run partially if the underlying catalog changes (as instructed by product updater 8311). This could be relevant, for example, to dynamic EPSs as described herein above. Product updater 8311 may ensure that all e-shops with the umbrella of WBS 2 that are using a particular product/EPS/partial EPS are all automatically updated accordingly.

System 200 may also offer a collection of selected templates that differ from the matched templates (as described in U.S. Pat. No. 9,747,258 entitled “System and Method for the Creation and Use of Visually-Diverse High-Quality Dynamic Layouts” granted Aug. 29, 2017, commonly owned by the Applicant and incorporated herein by reference) to provide different visuals to different e-shops for the same EPSs. Such a collection may be displayed as is or used in conjunction with the data from the selected EPS (thus creating multiple preview copies of alternative e-shops with different designs).

E-shop previewer 835 may offer a preview mode in which one or more (concurrent) previews of e-shops are shown. Such a mode may display multiple concurrent sites, including site features such as long pages, multiple pages, navigation, external interfaces etc.

E-shop previewer 835 may generate (one or more) e-shop previews that are run in “playground mode”. Such an e-shop preview may provide the full functionality, workflow, and user interface without creating any persistent side effects (when running in such playground mode).

It will be appreciated that when running in such a playground mode, the e-shop may provide dummy credit details or allow entering a credit card without actually charging it whenever the user provides payment details. Similarly, the playground mode e-shop may enable the user to complete the ordering and shipping details UI, and provide all required confirmation and responses, but without causing any actual order to be placed with the supplier. System 200 may also include dummy entries in the underlying databases (e.g., orders marked as “dummy” so that the user could also track the order through the backend system), without actual persistent side effects and may also provide an option to remove these dummy entries quickly.

E-shop previewer 835 may also create a preview of the generated e-shop in other ways. For example, e-shop previewer 835 may present one or more e-shops via a preview display, such as a generated video or animation of the e-shop(s). Website analyzer 8351 may scan the generated e-shop to determine the e-shop elements to be presented in the preview display, and in what way and order (e.g., based on predefined rules, website parameters and elements, such as described in U.S. Pat. No. 9,747,258). Alternatively, website analyzer 8351 may use an ML model 825.

It will be appreciated that the discussion above is focused on the templates used for the display of each product in the e-shop. However, system 200 may support templates that control the way the multiple products are organized (repeater-level templates). For example, these templates could include multiple object container forms, such as various gallery types. The e-shop designer may select such a higher-order template which may be separate from the selection of the per-product templates.

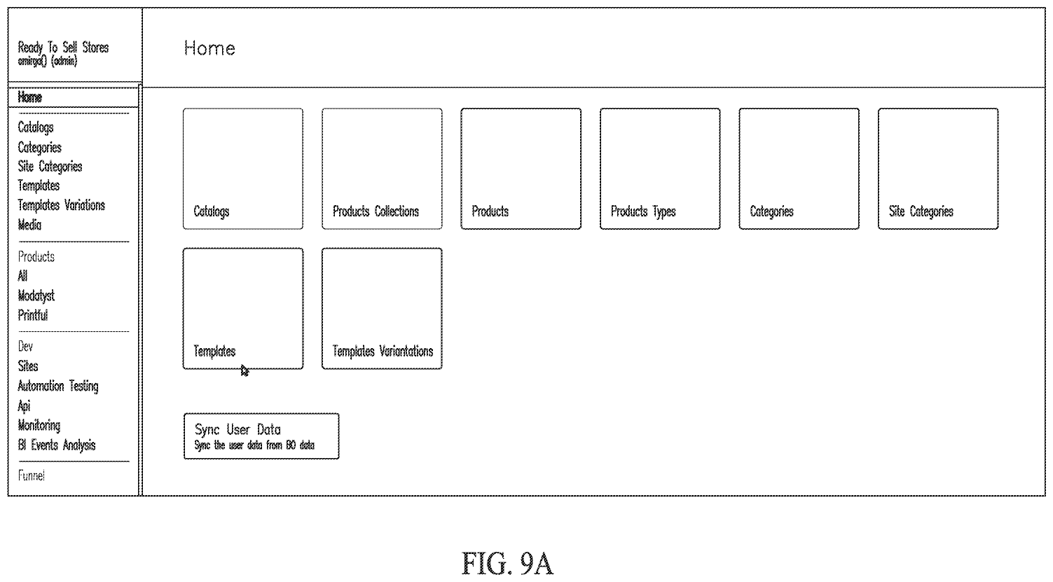

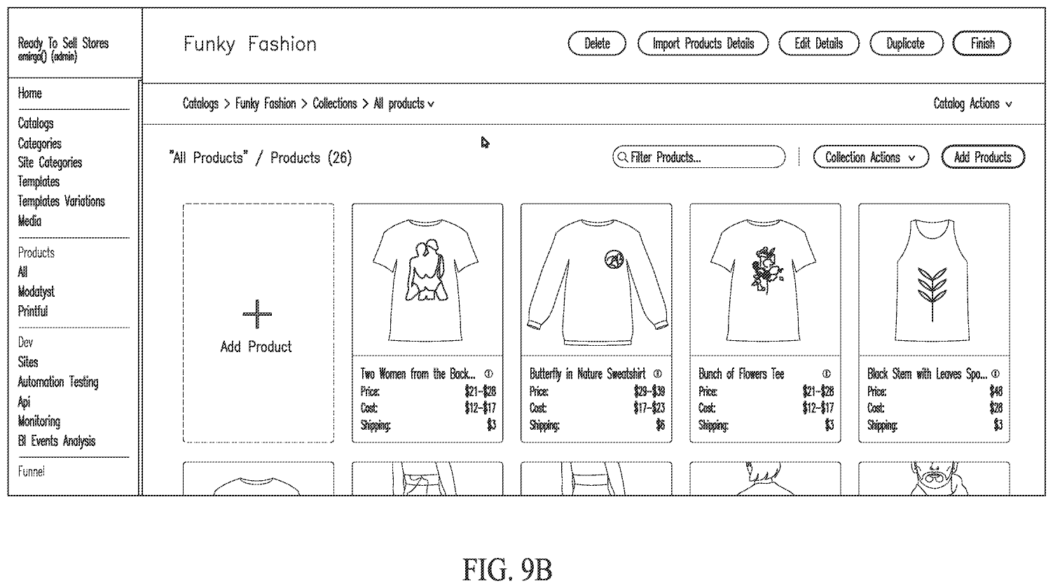

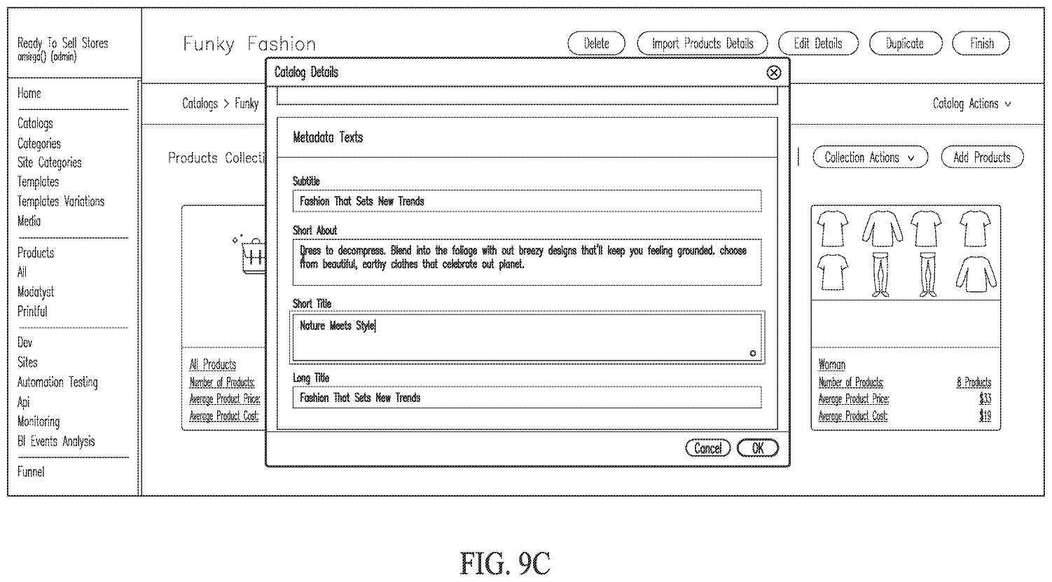

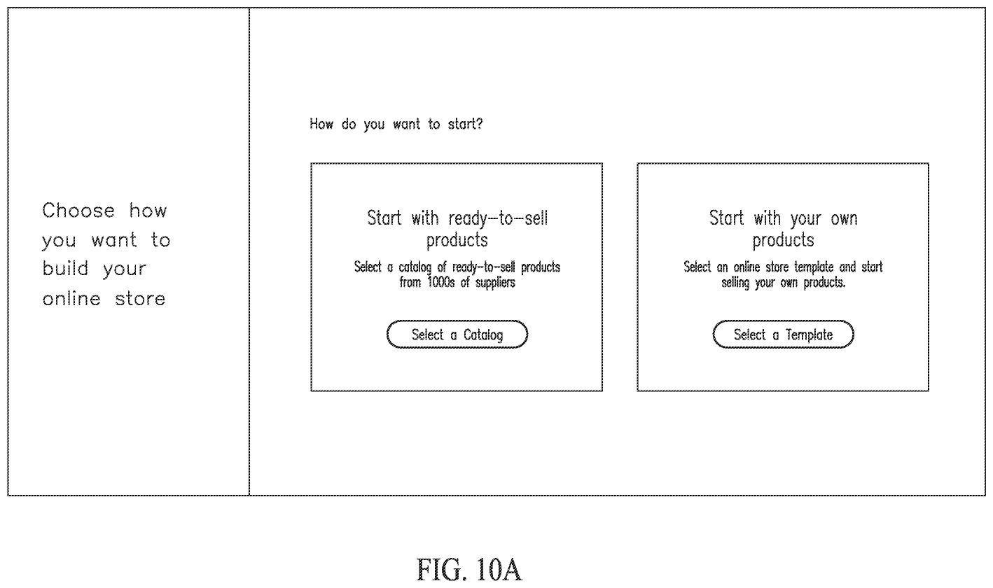

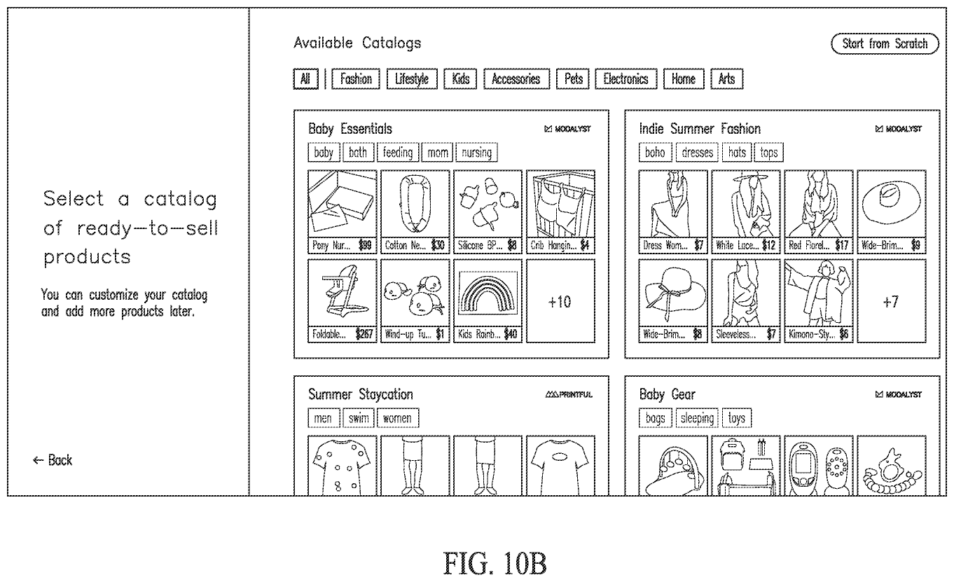

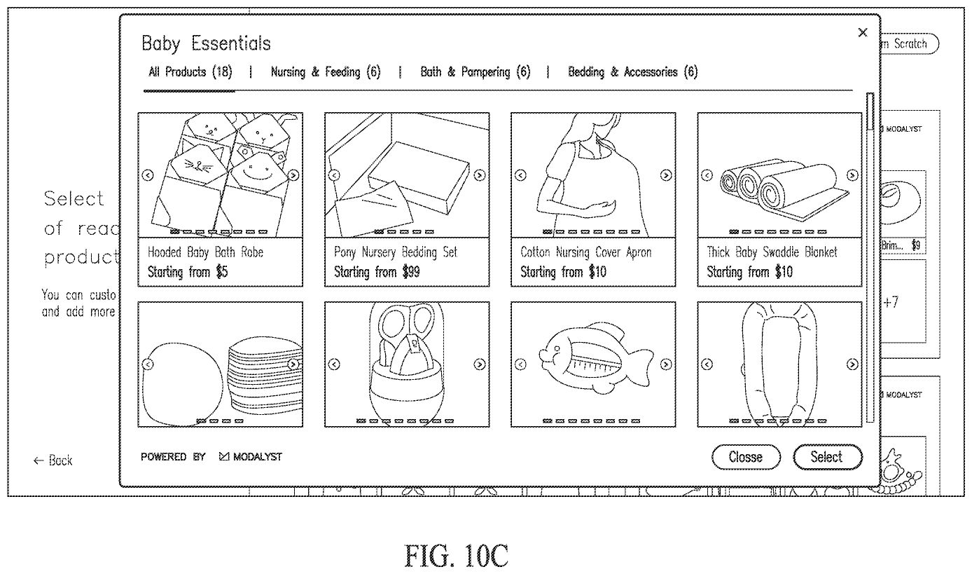

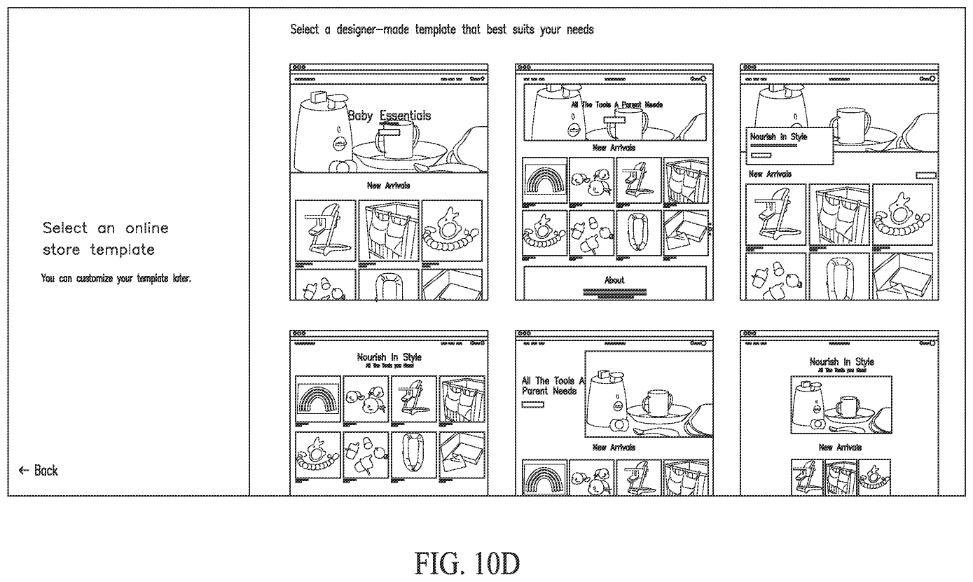

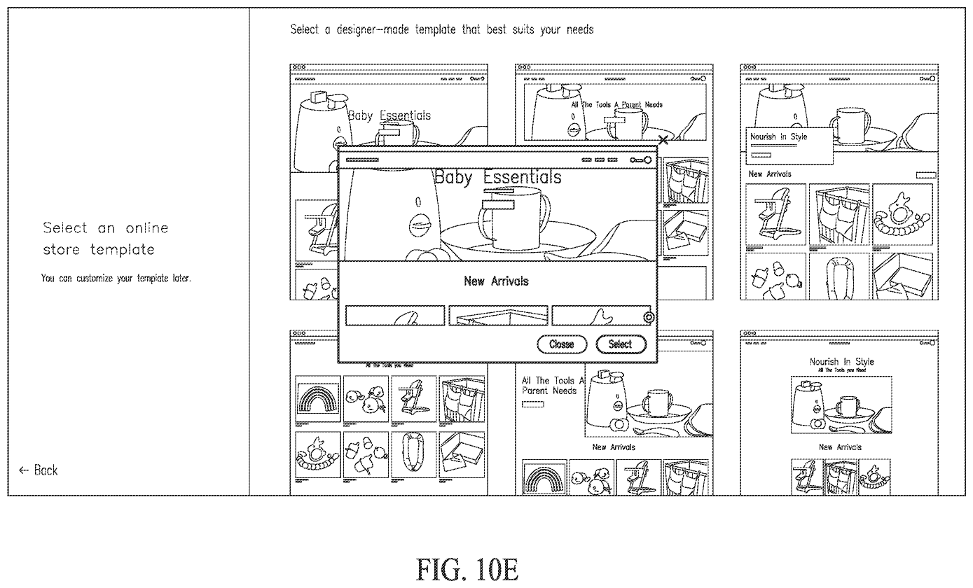

Reference is now made to FIGS. 9A to 9C and to FIGS. 10A to 10D which illustrate sample UIs for EPS building and for EPS use by a merchant accordingly.

The described UIs indicate a workflow using the embodiment of system 200 (system 80 integrated with WBS 2). The integration with a specific drop-shipper (or another vendor) is created by incorporating a third-party application providing this integration into the e-shop website. For example, to connect to a drop-shipping service, e-shop builder 83 may include the drop-shipping service third party application from object marketplace 15. System 200 may allow the merchant to do this at various stages of the e-shop building, e.g., before or after adding the EPS.

Reference is now made to FIG. 9A which illustrates an EPS generator tool 81 integrated with an e-shop management dashboard for building different elements of an e-shop.

Reference is now made to FIG. 9B which shows an interface with EPS editor 811 (with options to import product details, delete a product, edit product details, etc.)

It will be appreciated that EPS generator tool 81 may support selecting products from a large offering set and spatial EPS evaluator 816 may make sure the sure the EPS is harmonious. It will be appreciated that this ability to choose a set of products that have synergy between them is critical to the success of the EPS. Such product selection may be based on the catalog curator expertise and may also be performed automatically by EPS generator tool 81) or using recommendations from recommender 823 as described herein above.

It will be appreciated that the EPS design process may include EPS editor 811 having metadata and product data fields for the EPS itself as illustrated in FIG. 9C to which reference is now made. The example data fields include product subtitle, short “about” text, and long product title. This metadata is matched with templates used to display the EPS to support the template association process by EPS template associator 832. The template may expect specific types of metadata, so some of the metadata may not be needed for some templates.

Reference is now made to FIG. 10A which shows a prompt to the merchant whether he wants to start with a live collection (ready-to-sell) or select and define his own products.

Assuming the user has selected the ready-to-sell option, FIG. 10B illustrates the display of a set of relevant functional EPS (as recommended by recommender 823). The merchant may then select a suitable EPS or collection from the list of suggested EPSs. The merchant may also preview a given EPS in conjunction with one or more possible display templates using e-shop previewer 835.

Reference is now made to FIG. 10C which illustrates an example preview of the selected EPS.

Reference is now made to FIG. 10D which illustrates the selected EPS with multiple templates. The different templates are shown with the same selected EPS pre-filled with catalog product and extra information. This capability may allow the user to preview multiple versions of the entire site. It will be appreciated specific products or product sets can have their private template associations which override or are overridden by EPS template associator 832 in order to display alternative templates.

FIG. 10E shows a detailed preview of a specific EPS and template combination (including auto-scrolling on a single page site). Embodiments of system 200 may also provide multiple concurrent versions of the generated e-shop, or “almost live” versions as described herein above.

As discussed herein above, system 200 may offer the merchant the ability to add a drop-shipper. The system 80 provider may include integrations with one or more drop-shippers or other fulfillment services or venues (e.g., through third party applications as described herein above). The merchant could then select which drop-shipper to use (at this point in the UI or later). The catalog curator may also pre-specify which products are (or should be) associated with drop-shippers.

It will be appreciated that the drop-shipper's requirements may change as the merchant edits the product set (e.g., from that initially include in a selected EPS). For example, the merchant may add products requiring specific suppliers or remove all products which required a specific supplier.

It will also be appreciated that the merchant may also defer this installation and finalize the drop-shippers association only later. The e-shop would still be active but would not fulfill orders for products for which the drop-shipper connection has not been finalized.

It will be further appreciated that if some or all products are not associated with a drop-shipper or other fulfilment service system may display them with an “out of stock” indication. When drop-shipping is not generated, all products are “out of stock” (as system 80 doesn't have available stock information right now). This would typically happen because the merchant selected “add later”, i.e., without using a “ready to sell” collection which already has a backend connection. In another embodiment, the merchant may be able to connect such products separately to a drop-shipper or multiple drop shippers.

Therefore, the use of system 80 and EPSs at both the set and at the catalog level, may allow for an efficient way of creating e-shops with dynamic catalogs providing recommendations to products and their display including automatic updating to provide continually updated (for example) fulfillment, drop shipping and backend information.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

Embodiments of the present invention may include apparatus for performing the operations herein. This apparatus may be specially constructed for the desired purposes, or it may comprise a computing device or system typically having at least one processor and at least one memory, selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus. The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for creating and using enabled products sets (EPSs), the system comprising:
a processor; and
an e-shop developer system running on said processor in communication with a website building system (WBS), said e-shop developer system to create, modify and update at least one EPS for display in at least one e-shop of a website of said WBS; said at least one EPS to provide continuously updated fulfillment and backend information for its products, said e-shop developer system comprising:
an EPS generator tool to provide manual creation and editing services and automatic creation and updating of said at least one EPS;
an e-shop builder to receive a user selected at least one EPS and to match said at least one user selected EPS to at least one template for display within said at least one e-shop; and
an evaluation and integration engine to provide recommendations for said EPS generator tool and said e-shop builder according to at least one of: definitions of said website, site designer information, e-shop end-user activity internal and external to said e-shop developer system, industry standard databases and at least one ML (machine learning) model.

2. The system according to claim 1 wherein said e-shop developer system is integrated with said WBS.

3. The system according to claim 1 and further comprising at least one database to store at least one of: website definitions, e-commerce information, site designer information, editing history of said website, business information of said website, content of said website and site user information.

4. The system according to claim 1 wherein said EPS generator tool further comprises at least one of:
an EPS editor to enable said user to create and edit said at least one EPS;
an updater to handle both manual and automatic updates to products and their attributes of said at least one EPS from different sources;
a schema matcher to map between a supplier product information schema and said e-shop developer system schema for products of said at least one EPS;
a questionnaire presenter to present at least one questionnaire to said user and to receive input for said evaluation and integration engine from said at least one questionnaire;
a spatial EPS evaluator to evaluate at least one of: completeness, diversity and fulfillment optimization for said at least one EPS; and
an automatic EPS generator to create said at least one EPS according to said updater, said schema matcher, said questionnaire presenter and said spatial EPS evaluator.

5. The system according to claim 4 wherein said updater further comprises at least one of:
an API handler to communicate with a product supplier to receive fulfillment and product update information for a product; and
a change merge module to manage the merging of said product update information with changes made by said user.

6. The system according to claim 5 wherein said API handler uses at least one of an API (application programming interface), an SPI (Service provider interface), a web services based connection and system to system communication.

7. The system according to claim 1 wherein said e-shop builder comprises at least one of:
an e-shop editor to enable said user to select and edit said user selected at least one EPS for said at least one e-shop;
an EPS template associator to find templates to display said user selected at least one EPS using pre-associations;
an EPS template searcher to search in template repositories and provide automatic template construction for said user selected at least one EPS;
an EPS template generator to generate said at least one template for said user selected at least one EPS at runtime; and
an e-shop previewer to provide a preview of said at least one e-shop before publication.

8. The system according to claim 3 wherein said evaluation and integration engine comprises:
an information gatherer to gather information from said at least one database and operational data from external monitoring or data collection systems;
at least one ML (machine learning) model;
a ML (machine learning) trainer to train said at least one ML model;
an information analyzer to analyze said gathered information to provide input for said at least one ML model; and
a recommender to make recommendations for said at least one EPS according to said information analyzer and said at least one ML model.

9. The system according to claim 8 wherein said information analyzer comprises at least one of:
a feature extractor to create feature vectors for said at least one ML model;
a channel effectiveness analyzer to determine channel effectiveness for channels of said at least one EPS, wherein said channels comprise at least different advertising platforms;
an aggregator to aggregate e-commerce information and operational data for said at least one EPS; and
and a scorer and ranker to provide scoring and ranking for at least one of: construction of said at least one EPS, construction of said at least one e-shop and shop access by said at least one e-shop end-user.

10. The system according to claim 1 wherein said user is at least one of a merchant, a catalog curator, a website designer, an e-shop designer, WBS vendor staff, a product supplier, a marketplace provider and a drop shipper.

11. A method for creating and using enabled products sets (EPSs), the method comprising:
creating, modifying and updating at least one EPS for display in at least one e-shop of a website of a website building system (WBS); said at least one EPS to provide continuously updated fulfillment and backend information for its products, said creating, modifying and updating comprising:
providing manual creation and editing services and automatic creation and updating of said at least one EPS;
receiving a user selected at least one EPS;
matching said at least one user selected EPS to at least one template for display within said at least one e-shop; and
providing recommendations for said EPS generator tool and matching builder according to at least one of: definitions of said website, site designer information, e-shop end-user activity internal and external to said e-shop developer system, industry standard databases and at least one ML (machine learning) model.

12. The method according to claim 11 and further comprising storing in at least one database at least one of: website definitions, e-commerce information, site designer information, editing history of said website, business information of said website, content of said website and site user information.

13. The method according to claim 11 wherein said providing manual creation and editing services further comprises at least one of:
enabling said user to create and edit said at least one EPS;
handling both manual and automatic updates to products and their attributes of said at least one EPS from different sources;
mapping between a supplier product information schema and said e-shop developer system schema for products of said at least one EPS;
presenting at least one questionnaire to said user;
receiving input for said providing recommendations from said presenting at least one questionnaire;
evaluating at least one of: completeness, diversity and fulfillment optimization for said at least one EPS; and
creating said at least one EPS according to said handling both manual and automatic updates, said mapping, said receiving input and said evaluating.

14. The method according to claim 13 wherein said handling both manual and automatic updates further comprises at least one of:
communicating with a product supplier to receive fulfillment and product update information for a product; and
managing the merging of said product update information with changes made by said user.

15. The method according to claim 14 wherein said communicating with a product supplier uses at least one of an API (application programming interface), an SPI (Service provider interface), a web services based connection and system to system communication.

16. The method according to claim 11 wherein said matching comprises at least one of:
enabling said user to select and edit said user selected at least one EPS for said at least one e-shop;
finding templates to display said user selected at least one EPS using pre-associations;
searching in template repositories and providing automatic template construction for said user selected at least one EPS;
generating said at least one template for said user selected at least one EPS at runtime; and
providing a preview of said at least one e-shop before publication.

17. The method according to claim 12 wherein said providing recommendations comprises:
gathering information from said at least one database and operational data from external monitoring or data collection systems;
using at least one ML model;
training said at least one ML model;
analyzing said gathered information from said gathering information to provide input for said for said at least one ML model; and
making recommendations for said at least one EPS according to said analyzing said gathered information and said using at least one ML model.

18. The method according to claim 17 wherein said analyzing said gathered information comprises at least one of:
creating feature vectors for said at least one ML model;
determining channel effectiveness for channels of said at least one EPS, wherein said channels comprise at least different advertising platforms;
aggregating e-commerce information and operational data for said at least one EPS; and
providing scoring and ranking for at least one of: construction of said at least one EPS, construction of said at least one e-shop and shop access by said e-shop end-user.

19. The method according to claim 11 wherein said user is at least one of a merchant, a catalog curator, a website designer, an e-shop designer, WBS vendor staff, a product supplier, a marketplace provider and a drop shipper.
